(19) United States
(12) Patent Application Publication
(10) Pub. No.: US 2005/0239532 A1
(43) Pub. Date: Oct. 27, 2005

(54) Gaming machine

(75) Inventor: Yukinori Inamura, Tokyo (JP)

Correspondence Address: ARENT FOX PLLC, 1050 CONNECTICUT AVENUE, N.W., SUITE 400, WASHINGTON, DC, 20036, US

(73) Assignee: ARUZE Corp.

(21) Appl. No.: 11/110,818

(22) Filed: Apr. 21, 2005

(30) Foreign Application Priority Data
Apr. 22, 2004 (JP) 2004-127154

(51) Int. Cl. A63F 13/00

(52) U.S. Cl. 463/16; 463/20; 463/13

(57) ABSTRACT

For example, in the variable display portion 21, in a case that the symbol “LOBSTER” is stopped and displayed on the first stop area 211, the symbol “J” is stopped and displayed on the second stop area 211 and the symbol “Q” is stopped and displayed on the third stop area 213, when the player touches the first stop area 211 by the finger 128, the symbol “LOBSTER” stopped and displayed on the first stop area 211 is displayed so as to spring and the effect sounds representing springing lobster are output.

### CROSS-REFERENCE TO THE RELATED APPLICATION (S)

This application is based upon and claims a priority from the prior Japanese Patent Application No. 2004-127154 filed on Apr. 22, 2004, the entire contents of which are incorporated herein by reference. This application is related to co-pending U.S. application entitled “GAMING MACHINE”, filed on even date with this application. The co-pending application is expressly incorporated herein by reference.

### BACKGROUND OF THE INVENTION

1. Field of the Invention

The present invention relates to a gaming machine in which a game is conducted by using symbols variably displayed and thereafter stopped.

2. Description of Related Art

In conventional gaming machines, for example, a slot machine, a plurality of reels are rotated for a predetermined time and coins are paid out corresponding to a symbol combination which is displayed when all reels are stopped. And in a case that slot machines are roughly classified based on kinds of reels, there exist a mechanical type of slot machine in which plural reels on each outer periphery of which symbols are formed are rotatably provided and a video slot machine in which a plurality of hypothetical reels (graphics of reels), which are displayed on a display device, are rotated.

And in the video slot machine, since there is no mechanical restriction against the symbols formed on each of the reels, it can be informed to a player that a game state becomes a winning state, in which coins are paid out, by changing display mode of the symbols, for example, by automatic pseudo rotation of the symbols around a horizontal axis line under a state that the reels are stopped. For example, see Japanese Unexamined publication No. 7-313659.

However, in the above video slot machine, a chance to change the display mode of the symbols is limited to a time when the game pays out awards, therefore the chance to appeal to the player by changing the display mode of the symbols is limited.

### SUMMARY OF THE INVENTION

Taking the above situation into consideration, the present invention has been done and has an object to provide a gaming machine in which a display mode of symbols stopped and displayed can be changed based on an operation by a player, thereby familiarity of the player for games can be increased.

In order to accomplish the above object, according to one aspect of the present invention, it is provided a gaming machine having a display device for variably displaying and stopping symbols thereon and a game controller for conducting a payout corresponding to a symbol combination stopped and displayed on the display device,
the gaming machine comprising:
a touch input device which is arranged on an image plane of the display device; and
a symbol movement device for changing a display mode of the symbol stopped and displayed on the display device when the symbol is touched through the touch input device.

According to the present invention, the display mode of the symbol stopped and displayed on the display device is changed by the symbol movement device, thereby the display mode of the symbol stopped and displayed on the display device can be changed by player's operation. Therefore, familiarity of the player for a game can be increased.

The above and further objects and novel features of the invention will more fully appear from the following detailed description when the same is read in connection with the accompanying drawings. It is to be expressly understood, however, that the drawings are for purpose of illustration only and not intended as a definition of the limits of the invention.

### BRIEF DESCRIPTION OF THE DRAWINGS

The accompanying drawings, which are incorporated in and constitute a part of this specification illustrate embodiments of the invention and, together with the description, serve to explain the objects, advantages and principles of the invention.

In the drawings,

FIG. 1 is an explanatory view showing a state that symbols are variably changed when a player touches to a symbol stopped and displayed through a touch panel,

FIG. 2 is a perspective view of a slot machine,

FIG. 3 is a front view of a control panel,

FIG. 4 is a block diagram of a control system in the slot machine,

FIG. 5 is a block diagram schematically showing a liquid crystal drive circuit for a lower liquid crystal display,

FIG. 6 is an explanatory view schematically showing symbol rows each of which is variably displayed on a variable display portion in a base game,

FIG. 7 is an explanatory view showing one of symbols which constructs a part of the symbol row,

FIG. 8 is an explanatory view showing winning combinations and payouts corresponding thereto,

FIG. 9 is an explanatory view showing a lottery table for the symbols which are stopped and displayed,

FIG. 10 is an explanatory view showing stop areas of five variable display portions,

FIG. 11 is an explanatory view showing the first pay line,

FIG. 12 is an explanatory view showing the second pay line,

FIG. 13 is an explanatory view showing the third pay line,

FIG. 14 is an explanatory view showing the fourth pay line,

FIG. 15 is an explanatory view showing the fifth pay line,

FIG. 16 is an explanatory view showing the sixth pay line,

FIG. 17 is an explanatory view showing the seventh pay line,

FIG. 18 is an explanatory view showing the eighth pay line,

FIG. 19 is an explanatory view showing the ninth pay line,

FIG. 20 is an explanatory view showing the tenth pay line,

FIG. 21 is an explanatory view showing the eleventh pay line,

FIG. 22 is an explanatory view showing the twelfth pay line,

FIG. 23 is an explanatory view showing the thirteenth pay line,

FIG. 24 is an explanatory view showing the fourteenth pay line,

FIG. 25 is an explanatory view showing the fifteenth pay line,

FIG. 26 is an explanatory view showing the sixteenth pay line,

FIG. 27 is an explanatory view showing the seventeenth pay line,

FIG. 28 is an explanatory view showing the eighteenth pay line,

FIG. 29 is an explanatory view showing the nineteenth pay line,

FIG. 30 is an explanatory view showing the twentieth pay line,

FIG. 31 is an explanatory view showing the twenty-first pay line,

FIG. 32 is an explanatory view showing the twenty-second pay line,

FIG. 33 is an explanatory view showing the twenty-third pay line,

FIG. 34 is an explanatory view showing the twenty-fourth pay line,

FIG. 35 is an explanatory view showing the twenty-fifth pay line,

FIG. 36 is a flowchart of a main process program,

FIG. 37 is a flowchart of a start acceptance process program,

FIG. 38 is a flowchart of a lottery process program,

FIG. 39 is a flowchart of a base game process program,

FIG. 40 is a flowchart of a free game process program,

FIG. 41 is an explanatory view showing a lottery table for the symbols which are stopped and displayed,

FIG. 42 is an explanatory view showing a state that one of the symbols constructing a part of the symbol row is variably changed and displayed,

FIG. 43 is a flowchart of a start acceptance process program,

FIG. 44 is a flowchart of a base game process program,

FIG. 45 is a flowchart of a program for variably changing the symbols,

FIG. 46 is an explanatory view schematically showing the symbol rows each of which is variably changed and displayed on the variable display portion in the bonus game, and

FIG. 47 is a flowchart of a base game process program executed in another embodiment.

### DETAILED DESCRIPTION OF THE PREFERRED EMBODIMENTS

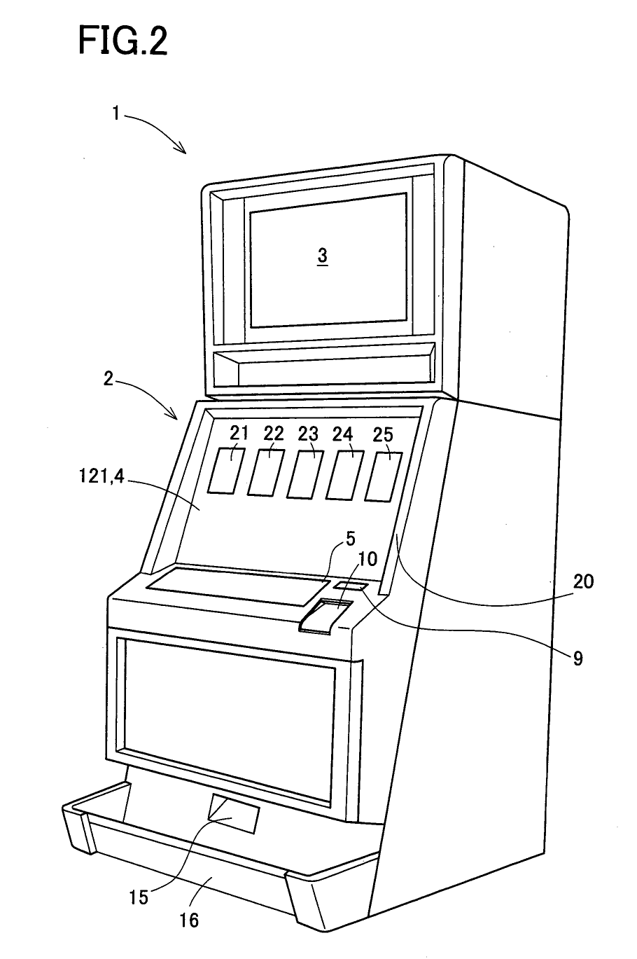

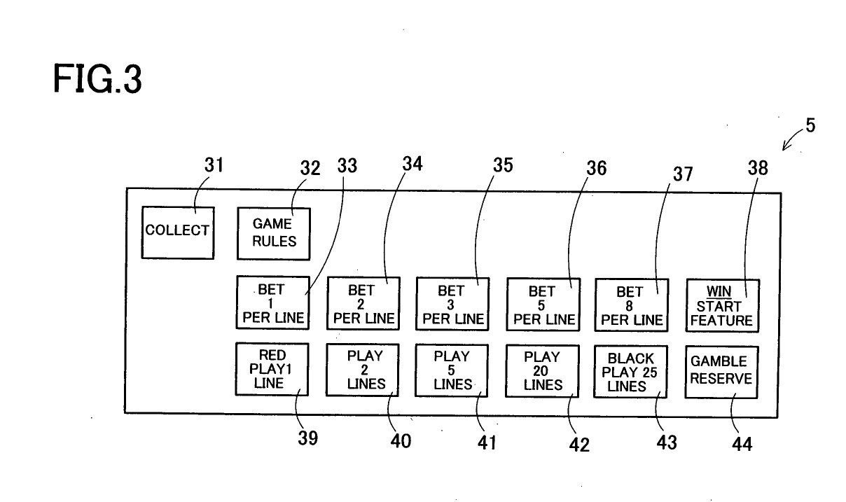

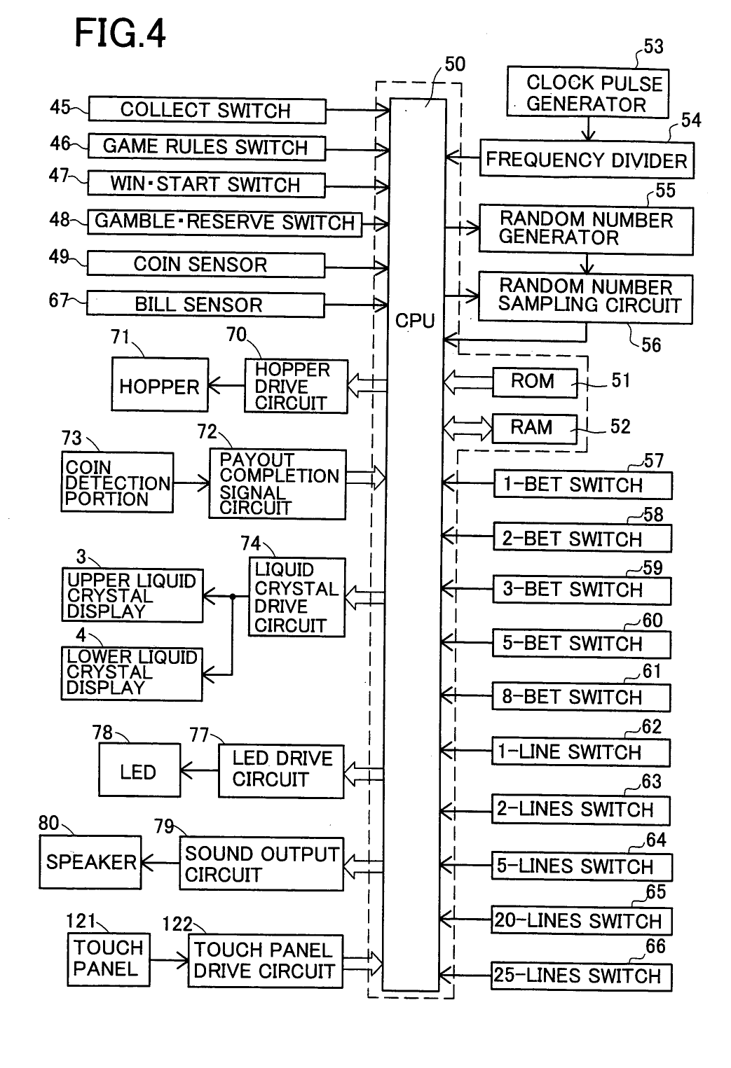

Hereinafter, concerning with a gaming machine according to the present invention, an embodiment embodying the present invention in a slot machine will be described in detail with reference to the drawings. First, an outline construction of the slot machine will be described with reference to FIGS. 2 to 4. FIG. 2 is a perspective view of the slot machine. FIG. 3 is a front view of a control panel. FIG. 4 is a block diagram schematically showing a control system of the slot machine.

In FIG. 2, the slot machine 1 has a cabinet 2 which forms whole construction of the slot machine 1. At an upper position of a front plane of the cabinet 2, an upper liquid crystal display 3 is arranged and a lower liquid crystal display 4 is arranged on a device front panel 20 which is arranged at a center position of the front plane of the cabinet 2. Here, both the upper liquid crystal display 3 and the lower liquid crystal display 4 are constructed from liquid crystal display generally used. On the upper liquid crystal display 3, it is indicated information concerning with a game such as methods, kinds of winning combinations and payouts corresponding thereto and various effects. And on a surface of the lower liquid crystal display 4, a touch panel 121 is arranged. Further, on the lower liquid crystal display 4, credits are displayed and five variable display portions 21, 22, 23, 24 and 25 are basically displayed as shown in FIG. 2. On each of the variable display portion 21, 22, 23, 24 and 25, various symbols are variably displayed while being scrolled from an upper direction toward a lower direction, thereafter stopped and displayed.

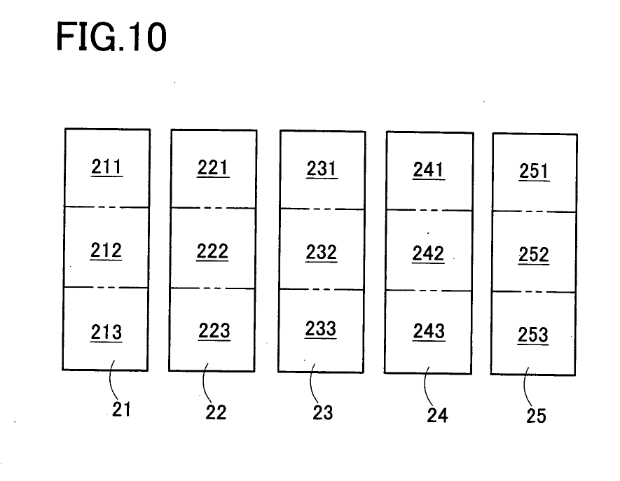

Therefore, in the slot machine 1 of the embodiment, a slot game (there exist a base game and a bonus game) is conducted through a video reels which are realized by displaying variable display portions 21 to 25 on the lower liquid crystal display 4. In the slot game (there exist a base game and a bonus game), there exist three symbols stopped and displayed on each of the variable display portions 21 to 25. That is to say, as shown in FIG. 10, the variable display portions 21 to 25 are divided into first stop areas 211, 221, 231, 241, 251, second stop areas 212, 222, 232, 242, 252, and third stop areas 213, 223, 233, 243, 253. And the symbols are respectively stopped and displayed on the stop areas 211˜213, 221˜223, 231˜233, 241˜243, 251˜253.

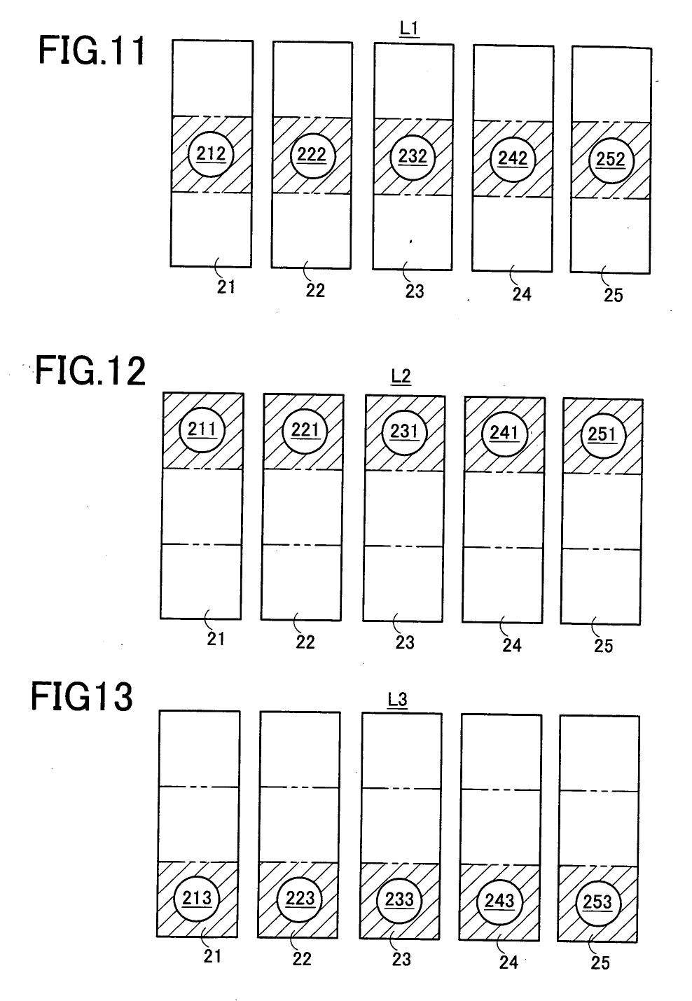

And in this slot game (base game and bonus game), there exist twenty-five pay lines, each spanning five stop areas among the stop areas 211˜213, 221˜223, 231˜233, 241˜243, 251˜253. If each of the pay lines is activated and specific symbols are aligned with a specific display mode along the activated pay line when the symbols are stopped and displayed, a predetermined payout is given to the player. Here, each of the pay lines will be concretely described with reference to FIGS. 11 to 35. In FIGS. 11 to 35, one pay line is indicated by shaded portions.

That is to say, as shown in FIG. 11 by shaded portions, the first pay line L1 is formed from the second stop areas 212, 222, 232, 242, 252.

And as shown in FIG. 12 by shaded portions, the second pay line L2 is formed from the first stop areas 211, 221, 231, 241, 251.

And as shown in FIG. 13 by shaded portions, the third pay line L3 is formed from the third stop areas 213, 223, 233, 243, 253.

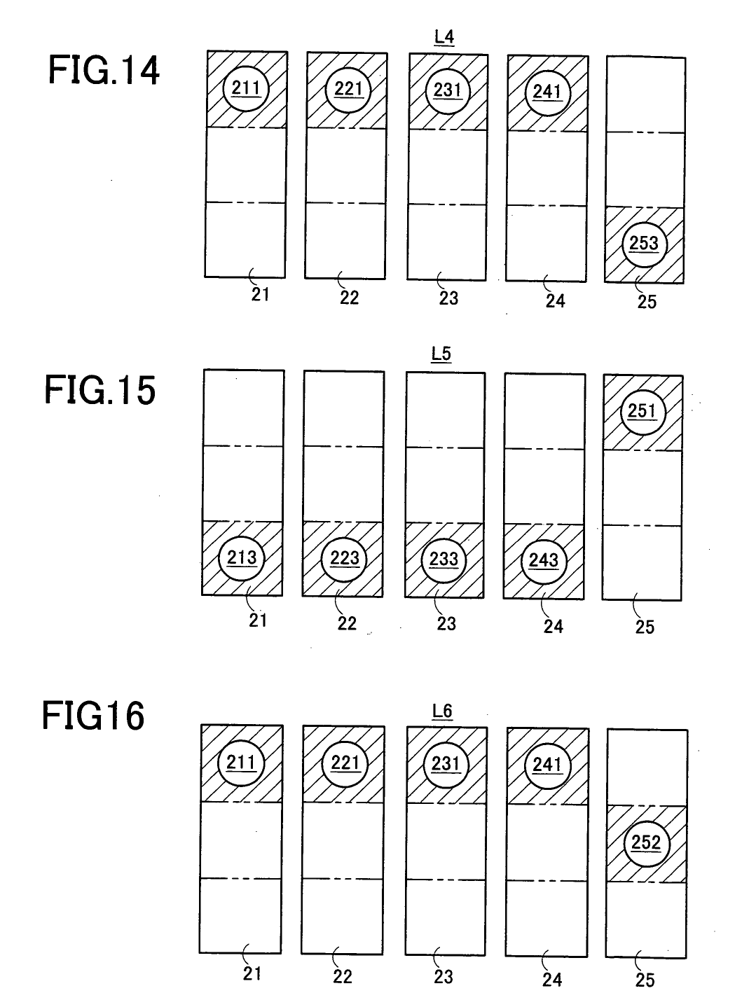

And as shown in FIG. 14 by shaded portions, the fourth pay line L4 is formed from the first stop areas 211, 221, 231, 241 and the third stop area 253.

And as shown in FIG. 15 by shaded portions, the fifth pay line L5 is formed from the first stop area 251 and the third stop areas 213, 223, 233, 243.

And as shown in FIG. 16 by shaded portions, the sixth pay line L6 is formed from the first stop areas 211, 221, 231, 241 and the second stop area 252.

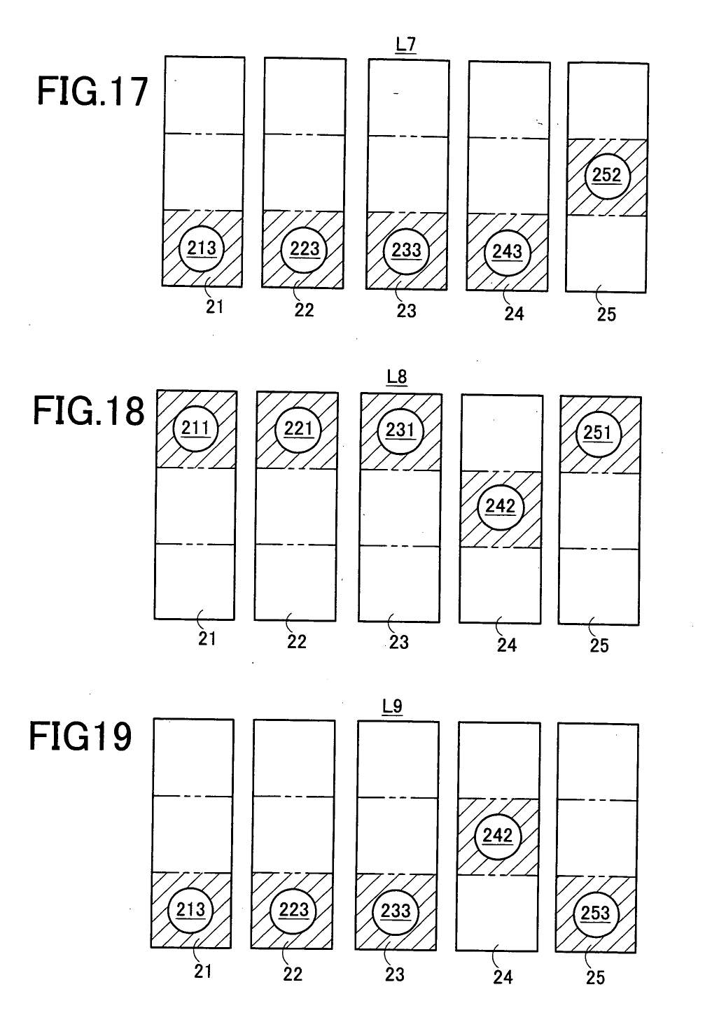

And as shown in FIG. 17 by shaded portions, the seventh pay line L7 is formed from the second stop area 252 and the third stop areas 213, 223, 233, 243.

And as shown in FIG. 18 by shaded portions, the eighth pay line L8 is formed from the first stop areas 211, 221, 231, 251 and the second stop area 242.

And as shown in FIG. 19 by shaded portions, the ninth pay line L9 is formed from the second stop area 242 and the third stop areas 213, 223, 233, 253.

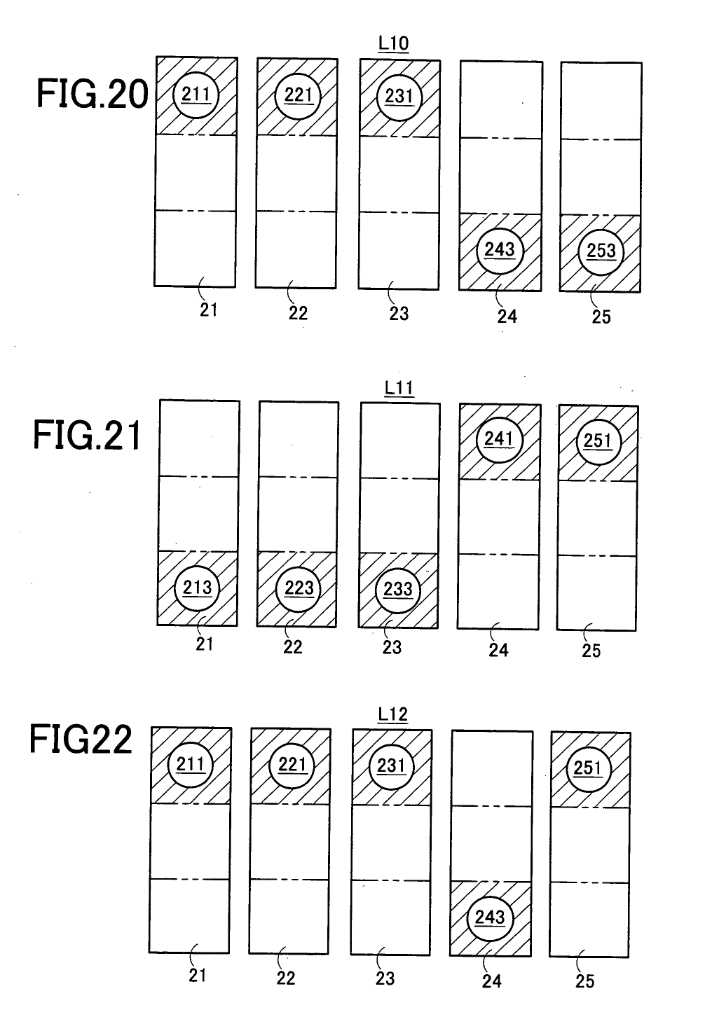

And as shown in FIG. 20 by shaded portions, the tenth pay line L10 is formed from the first stop areas 211, 221, 231 and the third stop areas 243, 253.

And as shown in FIG. 21 by shaded portions, the eleventh pay line L11 is formed from the first stop areas 241, 251 and the third stop areas 213, 223, 233.

And as shown in FIG. 22 by shaded portions, the twelfth pay line L12 is formed from the first stop areas 211, 221, 231, 151 and the third stop area 243.

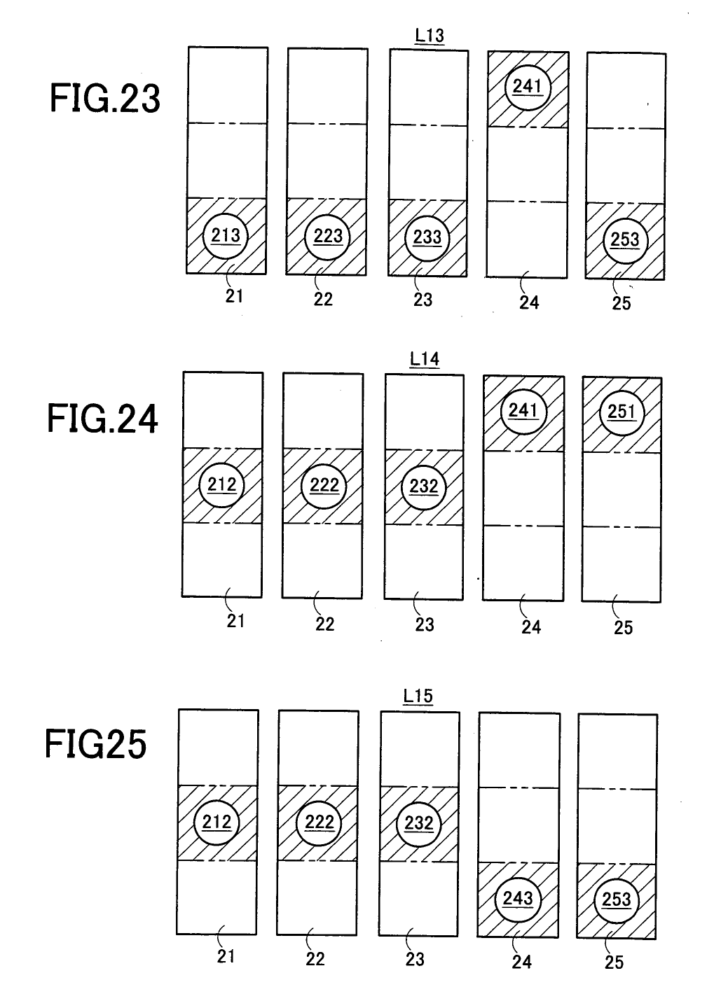

And as shown in FIG. 23 by shaded portions, the thirteenth pay line L13 is formed from the first stop area 241 and the third stop areas 213, 223, 233, 253.

And as shown in FIG. 24 by shaded portions, the fourteenth pay line L14 is formed from the first stop areas 241, 251 and the second stop areas 212, 222, 232.

And as shown in FIG. 25 by shaded portions, the fifteenth pay line L15 is formed from the second stop areas 212, 222, 232 and the third stop areas 243, 253.

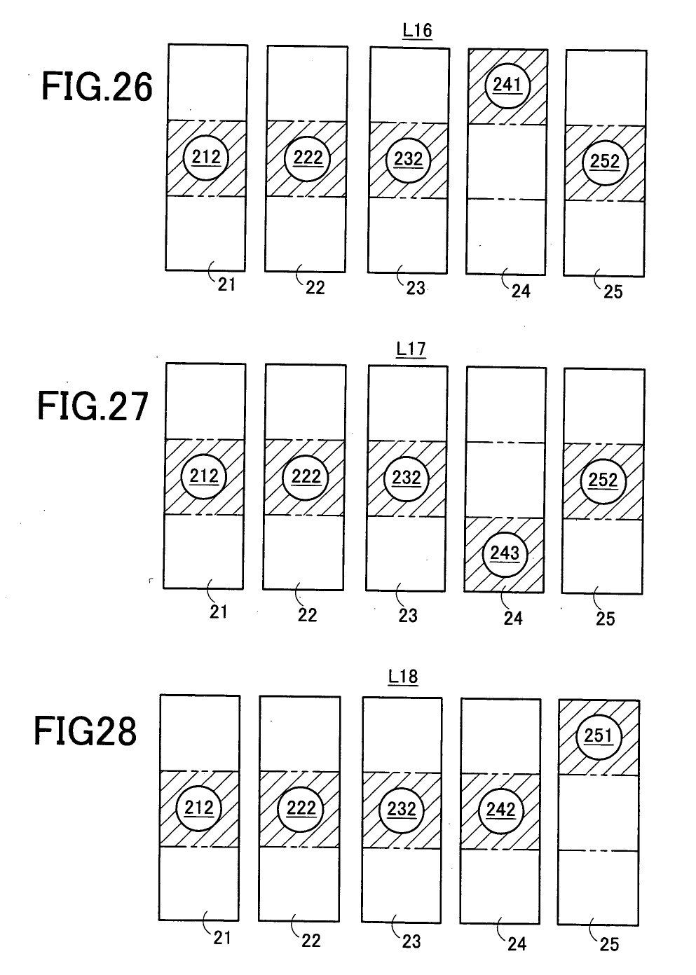

And as shown in FIG. 26 by shaded portions, the sixteenth pay line L16 is formed from the first stop area 241 and the second stop areas 212, 222, 232, 252.

And as shown in FIG. 27 by shaded portions, the seventeenth pay line L17 is formed from the second stop areas 212, 222, 232, 252 and the third stop area 243.

And as shown in FIG. 28 by shaded portions, the eighteenth pay line L18 is formed from the first stop area 251 and the second stop areas 212, 222, 232, 242.

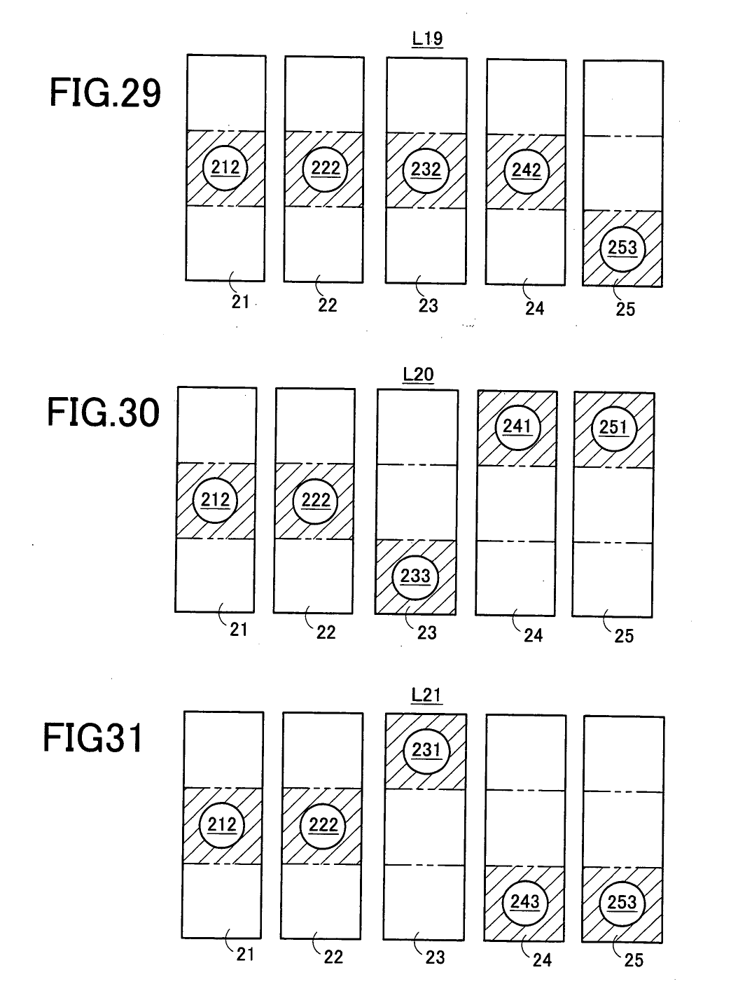

And as shown in FIG. 29 by shaded portions, the nineteenth pay line L19 is formed from the second stop areas 212, 222, 232, 242 and the third stop area 253.

And as shown in FIG. 30 by shaded portions, the twentieth pay line L20 is formed from the first stop areas 241, 251 and the second stop areas 212, 222 and the third stop area 233.

And as shown in FIG. 31 by shaded portions, the twenty-first pay line L21 is formed from the first stop area 231 and the second stop areas 212, 222 and the third stop areas 243, 253.

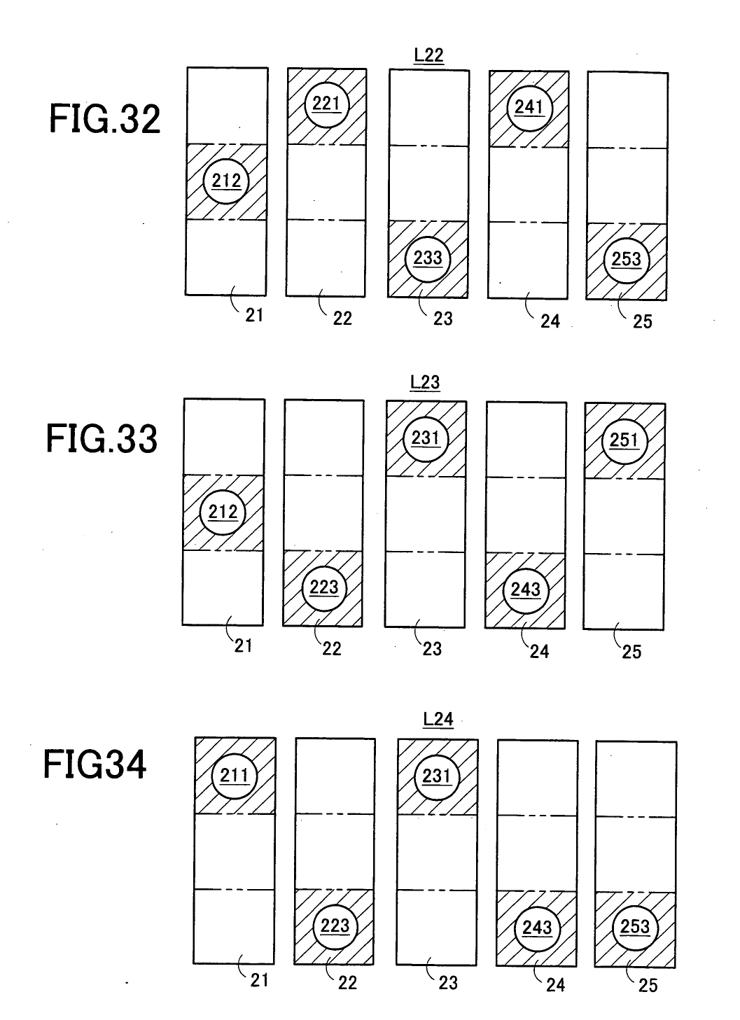

And as shown in FIG. 32 by shaded portions, the twenty-second pay line L22 is formed from the first stop areas 221, 241 and the second stop area 212 and the third stop areas 233, 253.

And as shown in FIG. 33 by shaded portions, the twenty-third pay line L23 is formed from the first stop areas 231, 251 and the second stop area 212 and the third stop areas 223, 243.

And as shown in FIG. 34 by shaded portions, the twenty-fourth pay line L24 is formed from the first stop areas 211, 231 and the third stop areas 223, 243, 253.

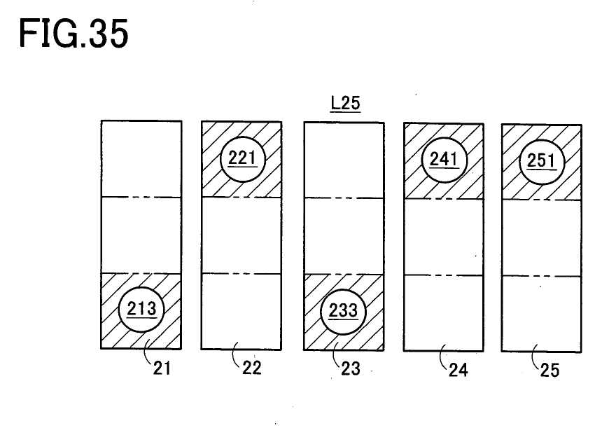

And as shown in FIG. 35 by shaded portions, the twenty-fifth pay line L25 is formed from the first stop areas 221, 241, 251 and the third stop areas 213, 233.

Here, the pay line (s) activated among the 25 pay lines is/are called as “activated pay line (s)”

Back to FIG. 2, at an lower position of the lower liquid crystal display 4, a control panel 5 which is projected forward is formed. In the control panel 5 as shown in FIG. 3, a COLLECT button 31 and a GAME RULES button 32 are arranged in an upper step from the most left side, and a BET 1 PER LINE button 33, a BET 2 PER LINE button 34, a BET 3 PER LINE button 35, a BET 5 PER LINE button 36, a BET 8 PER LINE button 37 and a WIN START FEATURE button 38 are arranged in a middle step from the most left side. Further, a RED PLAY 1 LINE button 39, a PLAY 2 LINES button 40, a PLAY 5 LINES button 41, a PLAY 20 LINES button 42, a BLACK PLAY 25 LINES button 43 and a GAMBLE RESERVE button 44 are arranged in a lower step from the most left side. And as shown in FIG. 2, at the right side of the control panel 5, a coin insertion slot 9 and a bill insertion portion 10 are provided.

Here, the COLLECT button 31 is a button which is pressed when the base game is terminated, and when the COLLECT button 31 is pressed, coins equal to the credits obtained in the game are paid out from a coin payout opening 15 to a coin tray 16. To the COLLECT button 31, a COLLECT switch 45 is attached and a switch signal is output to a CPU 50 from the COLLECT switch 45 on the basis of press of the COLLECT button 31 (see FIG. 4).

The GAME RULES button 32 is a button which is pressed if operation methods of the game cannot be understood, and when the GAME RULES button 32 is pressed, various help information is displayed on the upper liquid crystal display 3 or the lower liquid crystal display 4. To the GAME RULES button 32, a GAME RULES switch 46 is attached and a switch signal is output to the CPU 50 from the GAME RULES switch 46 on the basis of press of the GAME RULES button 32 (see FIG. 4).

To the coin insertion slot 9, a coin sensor 49 is arranged and when a coin is inserted in the coin insertion slot 9, a coin detection signal is output to the CPU 50 through the coin sensor 49 (see FIG. 4) and credit corresponding to the inserted coin is added. And to the bill insertion portion 10, a bill sensor 67 is arranged and when a bill is inserted in the bill insertion portion 10, a bill detection signal is output to the CPU 50 through the bill sensor 67 (see FIG. 4), and credit corresponding to the inserted bill is added.

The BET 1 PER LINE button 33 is a button to bet one credit to each of the activated pay lines every one press thereof. To this BET 1 PER LINE button 33, a 1-BET switch 57 is attached and when the BET 1 PER LINE button 33 is pressed, a switch signal is output to the CPU 50 from the 1-BET switch 57 (see FIG. 4). The BET 2 PER LINE button 34 is a button to start the game with 2 bets against each of the activated pay lines on the basis of press thereof. To the BET 2 PER LINE button 34, a 2-BET switch 58 is attached and when the BET 2 PER LINE button 34 is pressed, a switch signal is output to the CPU 50 from the 2-BET switch 58 (see FIG. 4).

The BET 3 PER LINE button 35 is a button to start the game wit 3 bets against each of the activated pay lines on the basis of press thereof. To the BET 3 PER LINE button 35, a 3-BET switch 59 is attached and when the BET 3 PER LINE button 35 is pressed, a switch signal is output to the CPU 50 from the 3-BET switch 59 (see FIG. 4). And the BET 5 PER LINE button 36 is a button to start the game with 5 bets against each of the activated pay lines on the basis of press thereof. To the BET 5 PER LINE button 36, a 5-BET switch 60 is attached and when the BET 5 PER LINE button 36 is pressed, a switch signal is output to the CPU from the 5-BET switch 60 (see FIG. 4).

The BET 8 PER LINE button 37 is a button to start the game with 8 bets against each of the activated pay lines on the basis of press thereof. To the BET 8 PER LINE button 37, a 8-BET switch 61 is attached and when the BET 8 PER LINE switch 37 is pressed, a switch signal is output to the CPU 50 from the 8-BET switch 61 (see FIG. 4).

Therefore, there will exist 1 bet, 2 bets, 3 bets, 5 bets and 8 bets as the bet number which can be betted by press of the BET 1 PER LINE button 33, the BET 2 PER LINE button 34, the BET 3 PER LINE button 35, the BET 5 PER LINE button 36 and the BET 8 PER LINE button 37.

The WIN START FEATURE button 38 is a button to start a bonus game or add the payout obtained in the bonus game to the credit on the basis of press thereof. To the WIN START FEATURE button 38, a WIN START switch 47 is attached and when the WIN START FEATURE button 38 is pressed, a switch signal is output to the CPU 50 from the WIN START switch 47 (see FIG. 4).

The RED PLAY 1 LINE button 39 is a button to start the game while retaining the number of the activated pay line to “1” on the basis of press thereof. To the RED PLAY 1 LINE button 39, a 1-LINE switch 62 is attached and when the RED PLAY 1 LINE button 39 is pressed, a switch signal is output to the CPU 50 from the 1-LINE switch 62 (see FIG. 4). And the PLAY 2 LINES button 40 is a button to start the game while retaining the number of the activated pay line to “2” on the basis of press thereof. To the PLAY 2 LINES button 49, a 2-LINES switch 63 is attached and when the PLAY 2 LINES button 40 is pressed, a switch signal is output to the CPU 50 from the 2-LINES switch 63 (see FIG. 4).

The PLAY 5 LINES button 41 is a button to start the game while retaining the number of the activated pay line to “5” on the basis of press thereof. To the PLAY 5 LINES button 41, a 5-LINES switch 64 is attached and when the PLAY 5 LINES button 41 is pressed, a switch signal is output to the CPU 50 from the 5-LINES switch 64 (see FIG. 4). And the PLAY 20 LINES button 42 is a button to start the game while retaining the number of the activated pay lien to “20” on the basis of press thereof. To the PLAY 20 LINES button 42, a 20-LINES switch 65 is attached and when the PLAY 20 LINES button 42 is pressed, a switch signal is output to the CPU 50 from the 20-LINES switch 65 (see FIG. 4).

The BLACK PLAY 25 LINES button 43 is a button to start the game while retaining the number of the activated pay line to “25” on the basis of press thereof. To the BLACK PLAY 25 LINES button 43, a 25-LINES switch 66 is attached and when the BLACK PLAY 25 LINES button 43 is pressed, a switch signal is output to the CPU 50 from the 25-LINES switch 66 (see FIG. 4).

Therefore, there will exist “1” pay line, “2” pay lines, “5” pay lines, “20” pay lines and “25” pay lines as the number of the activated pay lines which can be determined by press of the RED PLAY 1 LINE button 39, the PLAY 2 LINES button 49, the PLAY 5 LINES button 41, the PLAY 20 LINES button 42, the BLACK PLAY 25 LINES button 43.

Here, when the RED PLAY 1 LINE button 39 is pressed, the pay line L1 shown in FIG. 11 is activated. And when the PLAY 2 LINES button 40 is pressed, the pay lines L1, L2 shown in FIGS. 11 and 12 are activated. And when the PLAY 5 LINES button 41 is pressed, the pay lines L1˜L5 shown in FIGS. 11 to 15 are activated. And when the PLAY 20 LINES button 42 is pressed, the pay lines L1˜L20 shown in FIGS. 11 to 30 are activated. And when the BLACK PLAY 25 LINES button 43 is pressed, the pay lines L1˜L25 shown in FIGS. 11 to 35 are activated.

And each of the RED PLAY 1 LINE button 39, the PLAY 2 LINES button 49, the PLAY 5 LINES button 41, the PLAY 20 LINES button 42 and the BLACK PLAY 25 LINES button 43 is a button to start the game with the present bet number and the number of the activated pay lines and to start variable display of the symbols on each of the variable display portions 21 to 25 in the lower liquid crystal display 4.

Here, the RED PLAY 1 LINE button 39 and the BLACK PLAY 25 LINES button 43 are also used for selecting red or black in the double down game which is conducted by using the credit obtained in the bonus game.

The GAMBLE RESERVE button 44 is a button to be pressed when the player leaves the seat and to shift to the double down game after the bonus game is terminated. To the GAMBLE RESERVE button 44, a GAMBLE·RESERVE switch 48 is attached and when the GAMBLE RESERVE button 44 is pressed, a switch signal is output to the CPU 50 from the GAMBLE·RESERVE switch 48 (see FIG. 4).

And at a lower position of the cabinet 2, a coin payout opening 15 is formed and a coin tray 16 for receiving coins paid out from the coin payout opening 15 is provided. Within the coin payout opening 15 it is arranged a coin detection portion 73 (mentioned later) which is constructed from sensors and the like (see FIG. 4). And the coin detection portion 73 counts the number of coins paid out from the coin payout opening 15.

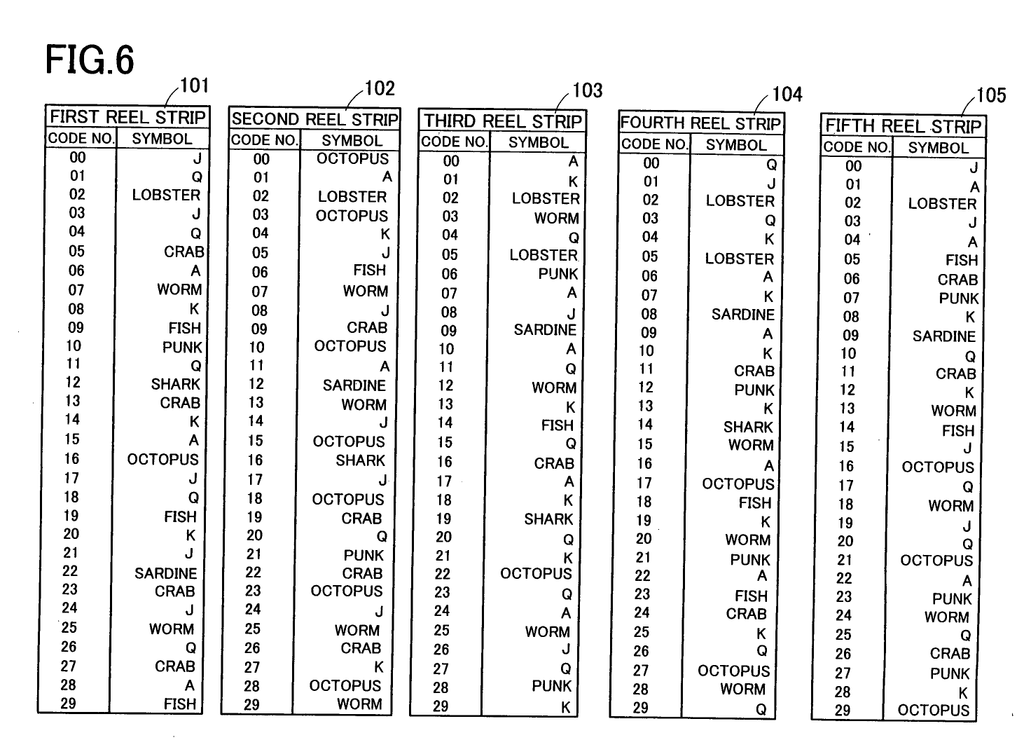

Next, with reference to FIG. 6, it will be described the symbol rows which are variable displayed while being scrolled on each of the variable display portions 21 to 25, the symbol rows being displayed on the lower liquid crystal display 4 in the base game. In FIG. 6, the symbol row indicated by a first reel strip 101 corresponds to a symbol row variably displayed on the variable display portion 21, the symbol row indicated by a second reel strip 102 corresponds to a symbol row variably displayed on the display portion 22, the symbol row indicated by a third reel strip 103 corresponds to a symbol row variably displayed on the variable display portion 23, the symbol row indicated by a fourth reel strip 104 corresponds to a symbol row variably displayed on the variable display portion 24 and the symbol row indicated by a fifth reel strip 105 corresponds to a symbol row variably displayed on the variable display portion 25.

Here, the symbol rows respectively indicated by the first to fifth reel strips 101 to 105 have different symbol rows from each other and each symbol row is constructed from 12 symbols by voluntarily combining “LOBSTER”, “SHARK”, “FISH”, “PUNK”, “OCTOPUS”, “CRAB”, “WORM”, “A”, “K”, “Q”, “J” and “SARDINE”.

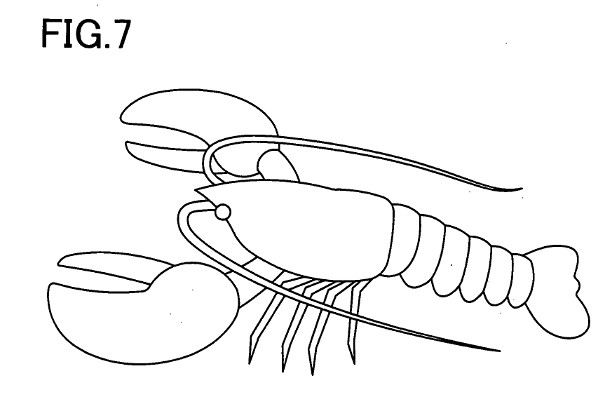

Here, “LOBSTER” shows the symbol of lobster as shown in FIG. 7. And although “SHARK”, “FISH”, “PUNK”, “OCTOPUS”, “CRAB”, “WORM”, “SARDINE” are not shown, each symbol shows a shark, a fish, a punk, an octopus, a crab, a worm and a sardine, respectively. And “A”, “K”, “Q” and “J” shows a symbol of English character, respectively.

Further, “SARDINE” is a scatter symbol to shift to the bonus game as mentioned later and in a case that more than three “SARDINE” symbols are totally displayed on the variable display portions 21 to 25, the game state can be shifted to the bonus game.

Here, in a case that the symbol rows indicated by the first to fifth reel strips 101 to 105 are scrolled on the variable display portions 21 to 25 and thereafter stopped and displayed, three symbols are stopped and displayed in each variable display portion, as mentioned in the above.

And various winning symbol combinations are preset based on plural kinds of symbol combinations and when the symbol combination corresponding to the winning symbol combination is stopped on the activated pay line, the payout is added to the credit corresponding to the winning symbol combination. This point is as same as that in the convention slot machine, thus explanation thereof will be omitted.

Next, it will be described a construction of control system in the slot machine 1 with reference to FIG. 4. FIG. 4 is a block diagram schematically showing a control system of the slot machine 1.

In FIG. 4, the control system of the slot machine 1 is basically constructed from a CPU 50, and a ROM 51 and a RAM 52 are connected to the CPU 50. In the ROM 51, a main process program mentioned later, a base game process program, a bonus game process program, a lottery table used when it is conducted lottery to determine the symbols which are stopped and displayed in the base game, a lottery table used when it is conducted lottery to determine the symbols which are stopped and displayed in the bonus game, and the other various programs necessary for control of the slot machine 1 and data tables. And the RAM 52 is a memory to temporarily store various data calculated by the CPU 50.

And to the CPU 50, a clock pulse generator 53 for generating standard clock pulses and a frequency divider 54 are connected, and a random number generator 55 for generating random numbers and a random number sampling circuit 56 are also connected. The random number sampled through the random number sampling circuit 56 is utilized in various lotteries of the winning symbol combinations and the like. Further, to the CPU 50, the COLLECT switch 45 attached to the COLLECT button 31, the GAME RULES switch 46 attached to the GAME RULES button 32, the 1-BET switch 57 attached to the BET 1 PER LINE button 33, the 2-BET switch 58 attached to the BET 2 PER LINES button 34, the 3-BET switch 59 attached to the BET 3 PER LINES button 35, the 5-BET switch 60 attached to the BET 5 PER LINES button 36, the 8-BET switch 60 attached to the BET 8 PER LINES button 37, the WIN·START switch 47 attached to the WIN START FEATURE button 38, the 1-LINE switch 62 attached to the RED PLAY 1 LINE button 39, the 2-LINES switch 63 attached to the PLAY 2 LINES button 40, the 5-LINES switch 64 attached to the PLAY 5 LINES button 41, the 20-LINES switch 65 attached to the PLAY 20 LINES button 42, the 25-LINES switch 66 attached to the BLACK PLAY 25 LINES button 43 and the GAMBLE RESERVE switch 48 attached to the GAMBLE RESERVE button 44 are connected, respectively. The CPU 50 conducts control to execute various operations each of which corresponds to each button, based on the switch signal output from each switch by press thereof.

Further, to the CPU 50, the coin sensor 49 arranged in the coin insertion slot 9 and the bill sensor 67 arranged in the bill insertion portion 10 are respectively connected. The coin sensor 49 detects coins inserted from the coin insertion slot 9 and the CPU 50 calculates the number of inserted coins based on the coin detection signal output from the coin sensor 49. The bill sensor 67 detects kinds and sum of the bill inserted from the bill insertion portion 10 and the CPU 50 calculates the credit number equal to the sum of bill, based on the bill detection signal output from the bill sensor 67.

To the CPU 50, a hopper 71 is connected through a hopper drive circuit 70. When a drive signal is output to the hopper drive circuit 70 from the CPU 50, the hopper 71 pays out a predetermined number of coins from the coin payout opening 15.

And to the CPU 50, a coin detection portion 73 is connected through a payout completion signal circuit 72. The coin detection portion 73 is arranged in the coin payout opening 15 and when the coin detection portion 73 detects that a predetermined number of coins are paid out from the coin payout opening 15, a coin payout detection signal is output to the payout completion signal circuit 72 from the coin detection portion 73, thereby the payout completion signal circuit 72 outputs a payout completion signal to the CPU 50. Further, to the CPU 50, the upper liquid crystal display 3 and the lower liquid crystal display 4 are connected through a liquid crystal drive circuit 74, and the upper liquid crystal display 3 and the lower liquid crystal display 4 are controlled by the CPU 50.

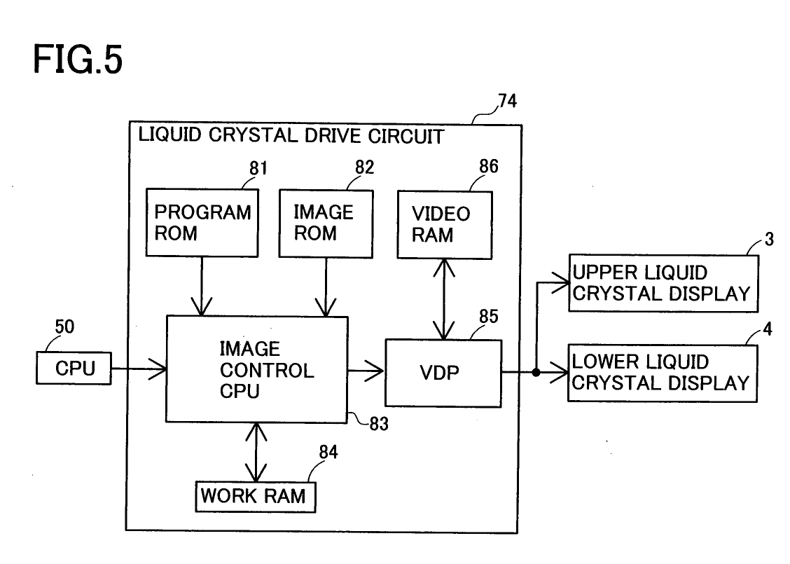

Here, as shown in FIG. 5, the liquid crystal drive circuit 74 is constructed from a program ROM 81, an image ROM 82, an image control CPU 83, a work RAM 84, a VDP (video display processor) 85 and a video RAM 68. And in the program ROM 81, there are stored an image control program for controlling display of the upper liquid crystal display 3 and the lower liquid crystal display 4 and various selection tables. And in the image ROM 82, for example, there are stored dot data for forming images of the symbol rows indicated by the first to fifth reel strips 101 to 105 in FIG. 6, such images being displayed on the lower liquid crystal display 4 (or variable display portions 21 to 25). And the image control CPU 83 determines the images displayed on the upper liquid crystal display 3 and the lower liquid crystal display 4 among the dot data stored beforehand in the image ROM 82, according to the image control program stored beforehand in the program ROM 81 based on parameters set by the CPU 50. Further, the work RAM 84 functions as temporary memory when the image control program is executed by the image control CPU 83. And the VDP 85 forms images corresponding to display contents determined by the image control CPU 83 and outputs such images to the upper liquid crystal display 3 and the lower liquid crystal display 4. Thereby, for example, the symbol rows indicated by the first to fifth reel strips 101 to 105 are scrolled and displayed on the lower liquid crystal display 4 (or the variable display portions 21 to 25). Here, the video RAM 86 functions as temporary memory when images are formed by the VDP 85.

And to the CPU 50, LEDs 78 are connected through a LED drive circuit 77. Many LEDs 78 are arranged on the front plane of the slot machine 1 and are controlled so as to turn on or turn off by the LED drive circuit 77 based on the drive signal from the CPU 50, when various effects are done. Further, a sound output circuit 79 and a speaker 80 are connected to the CPU 50 and the speaker 80 produces various effect sounds when various effects are conducted based on the output signal from the sound output circuit 79.

To the CPU 50, a touch panel 121 is connected through a touch panel drive circuit 122. The touch panel 121 is arranged on the image plane of the lower liquid crystal display 4 and when the player touches on the variable display portions 21 to 25 by the finger, the touch panel 121 can recognize through the touch panel drive circuit 122 not only the variable display portion on which the player touches among the variable display portions 21 to 25 but also the stop area on which the player touches among the first stop areas 211, 221, 231, 241, 151, the second stop areas 212, 222, 232, 242, 252 and the third stop areas 213, 223, 233, 243, 253.

That is to say, the touch panel 121 can recognize through the touch panel drive circuit 122 the variable display portion on which the player touches among the variable display portions 21 to 25, based on coordinate information of the portion which is touched by the player.

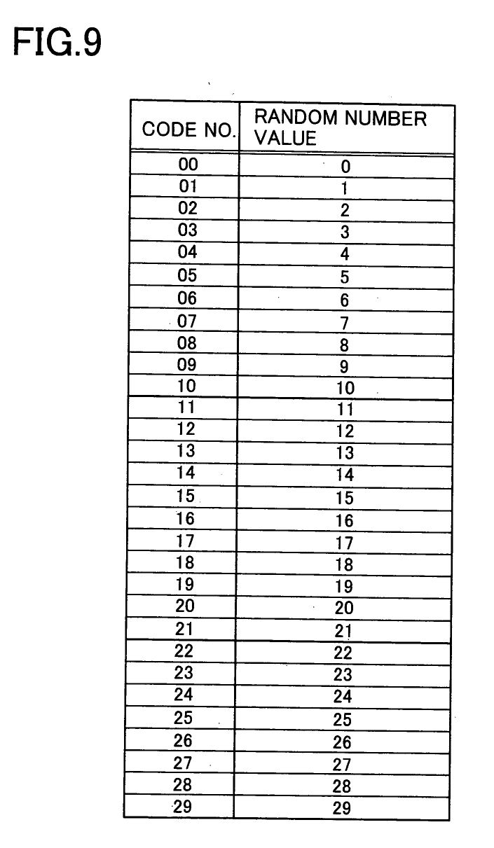

Here, it will be described with reference to FIG. 9 the lottery table which is used when the symbols stopped and displayed on the activated pay line L1 shown in FIG. 11 are determined, when the base game is conducted by using five variable display portions 21 to 25 in the slot machine 1.

The symbols stopped and displayed on the activated pay line L1 shown in FIG. 11 are determined every each of the variable display portions 21 to 25. In order to realize this, code Nos. “00”˜“29” are respectively allotted to the symbol in each symbol row indicated by the first to fifth reel strips 101 to 105 as shown in FIG. 6, in order of the upper most symbol. And the lottery table shown in FIG. 9 is provided beforehand. Further, five random numbers are sampled by the random number sampling circuit 56 so as to correspond to each of the variable display portions 21 to 25.

Hereinafter, the symbol row indicated by the first reel strip 101 in FIG. 6 will be described. The symbols in the symbol row are scrolled on the variable display portion 21. At that time, if the random number sampled by the random number sampling circuit 56 is “0”, the symbol “J” (English character) allotted to the code No. “00” is stopped and displayed on the activated pay line L1 shown in FIG. 11, if the random number is “1”, the symbol “Q” (English character) allotted to the code No. “01” is stopped and displayed on the activated pay line L1, if the random number is “2”, the symbol “LOBSTER” (lobster shown in FIG. 7) allotted to the code No. “02” is stopped and displayed on the activated pay line L1 shown in FIG. 11, if the random number is “3”, the symbol “J” (English character) allotted to the code No. “03” is stopped and displayed on the activated pay line L1 shown in FIG. 11, if the random number is “4”, the symbol “Q” (English character) allotted to the code No. “04” is stopped and displayed on the activated pay line L1 shown in FIG. 11, if the random number is “5”, the symbol “CRAB” allotted to the code No. “05” is stopped and displayed on the activated pay line L1 shown in FIG. 11, if the random number is “6”, the symbol “A” (English character) allotted to the code No. “06” is stopped and displayed on the activated pay line L1 shown in FIG. 11, if the random number is “7”, the symbol “WORM” allotted to the code No. “07” is stopped and displayed on the activated pay line L1 shown in FIG. 11, if the random number is “8”, the symbol “K” (English character) allotted to the code No. “08” is stopped and displayed on the activated pay line L1 shown in FIG. 11, if the random number is “9”, the symbol “FISH” allotted to the code No. “09” is stopped and displayed on the activated pay line L1 shown in FIG. 11, and if the random number is “10”, the symbol “PUNK” allotted to the code No. “10” is stopped and displayed on the activated pay line L1 shown in FIG. 11.

And if the random number is “11”, the symbol “Q” (English character) allotted to the code No. “11” is stopped and displayed on the activated pay line L1 shown in FIG. 11, if the random number is “12”, the symbol “SHARK” allotted to the code No. “12” is stopped and displayed on the activated pay line L1 shown in FIG. 11, if the random number is “13”, the symbol “CRAB” allotted to the code No. “13” is stopped and displayed on the activated pay line L1 shown in FIG. 11, if the random number is “14”, the symbol “K” (English character) allotted to the code No. “14” is stopped and displayed on the activated pay line L1 shown in FIG. 11, if the random number is “15”, the symbol “A” (English character) allotted to the code No. “15” is stopped and displayed on the activated pay line L1 shown in FIG. 11, if the random number is “16”, the symbol “OCTOPUS” allotted to the code No. “16” is stopped and displayed on the activated pay line L1 shown in FIG. 11, if the random number is “17”, the symbol “J” (English character) allotted to the code No. “17” is stopped and displayed on the activated pay line L1 shown in FIG. 11, if the random number is “18”, the symbol “Q” (English character) allotted to the code No. “18” is stopped and displayed on the activated pay line L1 shown in FIG. 11, and if the random number is “19”, the symbol “FISH” allotted to the code No. “19” is stopped and displayed on the activated pay line L1 shown in FIG. 11.

And if the random number is “20”, the symbol “K” (English character) allotted to the code No. “20” is stopped and displayed on the activated pay line L1 shown in FIG. 11, if the random number is “21”, the symbol “J” (English character) allotted to the code No. “21” is stopped and displayed on the activated pay line L1 shown in FIG. 11, if the random number is “22”, the symbol “SARDINE” allotted to the code No. “22” is stopped and displayed on the activated pay line L1 shown in FIG. 11, if the random number is “23”, the symbol “CRAB” allotted to the code No. “23” is stopped and displayed on the activated pay line L1 shown in FIG. 11, if the random number is “24”, the symbol “J” (English character) allotted to the code No. “24” is stopped and displayed on the activated pay line L1 shown in FIG. 11, if the random number is “25”, the symbol “WORM” allotted to the code No. “25” is stopped and displayed on the activated pay line L1 shown in FIG. 11, if the random number is “26”, the symbol “Q” (English character) allotted to the code No. “26” is stopped and displayed on the activated pay line L1 shown in FIG. 11, if the random number is “27”, the symbol “CRAB” allotted to the code No. “27” is stopped and displayed on the activated pay line L1 shown in FIG. 11, if the random number is “28”, the symbol “A” (English character) allotted to the code No. “28” is stopped and displayed on the activated pay line L1 shown in FIG. 11, and if the random number is “29”, the symbol “FISH” allotted to the code No. “29” is stopped and displayed on the activated pay line L1 shown in FIG. 11.

Here, as for the symbol row indicated by the second reel strip 102 in FIG. 6 the symbols of which are scrolled on the variable display portion 22, the symbol row indicated by the third reel strip 103 in FIG. 6 the symbols of which are scrolled on the variable display portion 23, the symbol row indicated by the fourth reel strip 104 in FIG. 6 the symbols of which are scrolled on the variable display portion 24 and the symbol row indicated by the fifth reel strip 105 in FIG. 6 the symbols of which are scrolled on the variable display portion 25, the above control is similarly conducted.

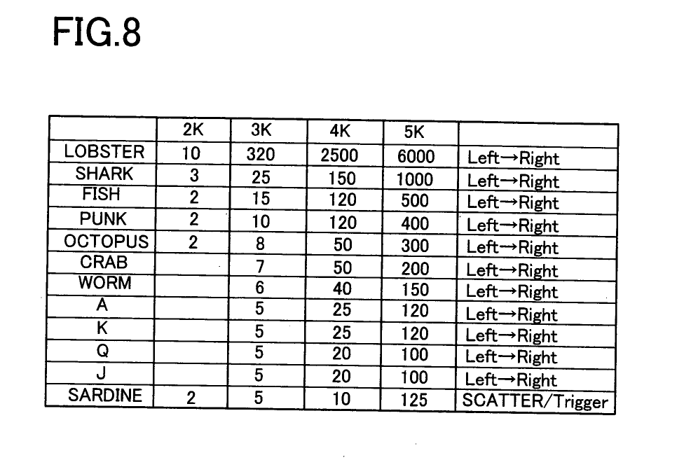

Next, with reference to FIG. 8, it will be described the winning symbol combinations and payouts thereof in a case that the base game is done by using five variable display portions 21 to 25 in the slot machine 1. FIG. 8 is an explanatory view showing the winning symbol combinations and payouts thereof in a case that the base game is done by using five variable display portions 21 to 25, and shows payouts in a case that the bet number is “1”. Therefore, if the bet number is “1”, the payout number shown in FIG. 8 is added to the credit, and if the bet number is more than “2”, the value obtained by multiplying the bet number with the payout number shown in FIG. 8 is added to the credit.

Here, concretely describing the winning symbol combinations and payouts thereof in the base game, as shown in FIG. 8, if the symbols “LOBSTER” (shown in FIG. 7) are stopped and displayed in series along the activated pay line on the variable display portions 21 and 22 (if two symbols “LOBSTER” appear in series from the left end (this case is called as “2K”)), the payout number “10” can be obtained. And if the symbols “LOBSTER” are stopped and displayed in series along the activated pay line on the variable display portions 21 to 23 (if three symbols “LOBSTER” appear in series from the left end (this case is called as “3K”)), the payout number “320” can be obtained. Further, if the symbols “LOBSTER” are stopped and displayed in series along the activated pay line on the variable display portions 21 to 24 (if four symbols “LOBSTER” appear in series from the left end (this case is called as “4K”)), the payout number “2500” can be obtained. And if the symbols “LOBSTER” are stopped and displayed in series along the activated pay line on the variable display portions 21 to 25 (if five symbols “LOBSTER” appear in series from the left end (this case is called as “5K”)), the payout number “6000” can be obtained.

And as for the symbol “SHARK”, if the symbols “SHARK” are stopped and displayed in series along the activated pay line on the variable display portions 21 and 22 (if two symbols “SHARK” appear in series from the left end (this case is called as “2K”)), the payout number “3” can be obtained. And if the symbols “SHARK” are stopped and displayed in series along the activated pay line on the variable display portions 21 to 23 (if three symbols “SHARK” appear in series from the left end (this case is called as “3K”)), the payout number “25” can be obtained. Further, if the symbols “SHARK” are stopped and displayed in series along the activated pay line on the variable display portions 21 to 24 (if four symbols “SHARK” appear in series from the left end (this case is called as “4K”)), the payout number “150” can be obtained. And if the symbols “SHARK” are stopped and displayed in series along the activated pay line on the variable display portions 21 to 25 (if five symbols “SHARK” appear in series from the left end (this case is called as “5K”)), the payout number “1000” can be obtained.

And as for the symbol “FISH”, if the symbols “FISH” are stopped and displayed in series along the activated pay line on the variable display portions 21 and 22 (if two symbols “FISH” appear in series from the left end (this case is called as “2K”)), the payout number “2” can be obtained. And if the symbols “FISH” are stopped and displayed in series along the activated pay line on the variable display portions 21 to 23 (if three symbols “FISH” appear in series from the left end (this case is called as “3K”)), the payout number “15” can be obtained. Further, if the symbols “FISH” are stopped and displayed in series along the activated pay line on the variable display portions 21 to 24 (if four symbols “FISH” appear in series from the left end (this case is called as “4K”)), the payout number “120” can be obtained. And if the symbols “FISH” are stopped and displayed in series along the activated pay line on the variable display portions 21 to 25 (if five symbols “FISH” appear in series from the left end (this case is called as “5K”)), the payout number “500” can be obtained.

And as for the symbol “PUNK”, if the symbols “PUNK” are stopped and displayed in series along the activated pay line on the variable display portions 21 and 22 (if two symbols “PUNK” appear in series from the left end (this case is called as “2K”)), the payout number “2” can be obtained. And if the symbols “PUNK” are stopped and displayed in series along the activated pay line on the variable display portions 21 to 23 (if three symbols “PUNK” appear in series from the left end (this case is called as “3K”)), the payout number “10” can be obtained. Further, if the symbols “PUNK” are stopped and displayed in series along the activated pay line on the variable display portions 21 to 24 (if four symbols “PUNK” appear in series from the left end (this case is called as “4K”)), the payout number “120” can be obtained. And if the symbols “PUNK” are stopped and displayed in series along the activated pay line on the variable display portions 21 to 25 (if five symbols “PUNK” appear in series from the left end (this case is called as “5K”)), the payout number “400” can be obtained.

And as for the symbol “OCTOPUS”, if the symbols “OCTOPUS” are stopped and displayed in series along the activated pay line on the variable display portions 21 and 22 (if two symbols “OCTOPUS” appear in series from the left end (this case is called as “2K”)), the payout number “2” can be obtained. And if the symbols “OCTOPUS” are stopped and displayed in series along the activated pay line on the variable display portions 21 to 23 (if three symbols “OCTOPUS” appear in series from the left end (this case is called as “3K”)), the payout number “8” can be obtained. Further, if the symbols “OCTOPUS” are stopped and displayed in series along the activated pay line on the variable display portions 21 to 24 (if four symbols “OCTOPUS” appear in series from the left end (this case is called as “4K”)), the payout number “50” can be obtained. And if the symbols “OCTOPUS” are stopped and displayed in series along the activated pay line on the variable display portions 21 to 25 (if five symbols “OCTOPUS” appear in series from the left end (this case is called as “5K”)), the payout number “300” can be obtained.

And as for the symbol “CRAB”, if the symbols “CRAB” are stopped and displayed in series along the activated pay line on the variable display portions 21 to 23 (if three symbols “CRAB” appear in series from the left end (this case is called as “3K”)), the payout number “7” can be obtained. Further, if the symbols “CRAB” are stopped and displayed in series along the activated pay line on the variable display portions 21 to 24 (if four symbols “CRAB” appear in series from the left end (this case is called as “4K”)), the payout number “50” can be obtained. And if the symbols “CRAB” are stopped and displayed in series along the activated pay line on the variable display portions 21 to 25 (if five symbols “CRAB” appear in series from the left end (this case is called as “5K”)), the payout number “200” can be obtained.

And as for the symbol “WORM”, if the symbols “WORM” are stopped and displayed in series along the activated pay line on the variable display portions 21 to 23 (if three symbols “WORM” appear in series from the left end (this case is called as “3K”)), the payout number “6” can be obtained. Further, if the symbols “WORM” are stopped and displayed in series along the activated pay line on the variable display portions 21 to 24 (if four symbols “WORM” appear in series from the left end (this case is called as “4K”)), the payout number “40” can be obtained. And if the symbols “WORM” are stopped and displayed in series along the activated pay line on the variable display portions 21 to 25 (if five symbols “WORM” appear in series from the left end (this case is called as “5K”)), the payout number “150” can be obtained.

And as for the symbol “A” (English character), if the symbols “A” are stopped and displayed in series along the activated pay line on the variable display portions 21 to 23 (if three symbols “A” appear in series from the left end (this case is called as “3K”)), the payout number “5” can be obtained. Further, if the symbols “A” are stopped and displayed in series along the activated pay line on the variable display portions 21 to 24 (if four symbols “A” appear in series from the left end (this case is called as “4K”)), the payout number “25” can be obtained. And if the symbols “A” are stopped and displayed in series along the activated pay line on the variable display portions 21 to 25 (if five symbols “A” appear in series from the left end (this case is called as “5K”)), the payout number “120” can be obtained.

And as for the symbol “K” (English character), if the symbols “K” are stopped and displayed in series along the activated pay line on the variable display portions 21 to 23 (if three symbols “K” appear in series from the left end (this case is called as “3K”)), the payout number “5” can be obtained. Further, if the symbols “K” are stopped and displayed in series along the activated pay line on the variable display portions 21 to 24 (if four symbols “K” appear in series from the left end (this case is called as “4K”)), the payout number “25” can be obtained. And if the symbols “K” are stopped and displayed in series along the activated pay line on the variable display portions 21 to 25 (if five symbols “K” appear in series from the left end (this case is called as “5K”)), the payout number “120” can be obtained.

And as for the symbol “Q” (English character), if the symbols “Q” are stopped and displayed in series along the activated pay line on the variable display portions 21 to 23 (if three symbols “Q” appear in series from the left end (this case is called as “3K”)), the payout number “5” can be obtained. Further, if the symbols “Q” are stopped and displayed in series along the activated pay line on the variable display portions 21 to 24 (if four symbols “Q” appear in series from the left end (this case is called as “4K”)), the payout number “20” can be obtained. And if the symbols “Q” are stopped and displayed in series along the activated pay line on the variable display portions 21 to 25 (if five symbols “Q” appear in series from the left end (this case is called as “5K”)), the payout number “100” can be obtained.

And as for the symbol “J” (English character), if the symbols “J” are stopped and displayed in series along the activated pay line on the variable display portions 21 to 23 (if three symbols “J” appear in series from the left end (this case is called as “3K”)), the payout number “5” can be obtained. Further, if the symbols “J” are stopped and displayed in series along the activated pay line on the variable display portions 21 to 24 (if four symbols “J” appear in series from the left end (this case is called as “4K”)), the payout number “20” can be obtained. And if the symbols “J” are stopped and displayed in series along the activated pay line on the variable display portions 21 to 25 (if five symbols “J” appear in series from the left end (this case is called as “5K”)), the payout number “100” can be obtained.

And in a case that the above payout is realized on plural activated pay lines, all payouts are added to the credit.

On the other hand, as for the symbol “SARDINE”, if two symbols “SARDINE” appear (are stopped and displayed) on the variable display portions 21 to 25 with no relation to the activated pay lines, that is, if the case “2K” is realized, the payout number “2” can be obtained. If three symbols “SARDINE” appear (are stopped and displayed) on the variable display portions 21 to 25 with no relation to the activated pay lines, that is, if the case “3K” is realized, the payout number “5” can be obtained. And if four symbols “SARDINE” appear (are stopped and displayed) on the variable display portions 21 to 25 with no relation to the activated pay lines, that is, if the case “4K” is realized, the payout number “10” can be obtained. Further, if five symbols “SARDINE” appear (are stopped and displayed) on the variable display portions 21 to 25 with no relation to the activated pay lines, that is, if the case “5K” is realized, the payout number “125” can be obtained.

Here, concerning with only the payout obtained by the symbol “SARDINE”, the payout number calculated by multiplying the payout number shown in FIG. 8 with the total bet number (a product of the bet number and the number of activated pay line) is added to the credit. At that time, if it exists the payout other than the payout on the basis of the symbol “SARDINE”, such payout is also added to the credit.

And as for the symbol “SARDINE”, in a case that more than three symbols “SARDINE” are totally stopped and displayed on the variable display portions 21 to 25 with no relation to the activated pay lines, not only the above payout can be obtained but also the game state can be shifted to the bonus game.

Here, the bonus game is a game which is conducted after the base game is terminated, and in many cases the bonus game is generally more beneficial for the player. If the game state shifts to the bonus game, 15˜25 games can be continuously and automatically done without betting any credits corresponding to a result of the lottery conducted when the game state shifts to the bonus game.

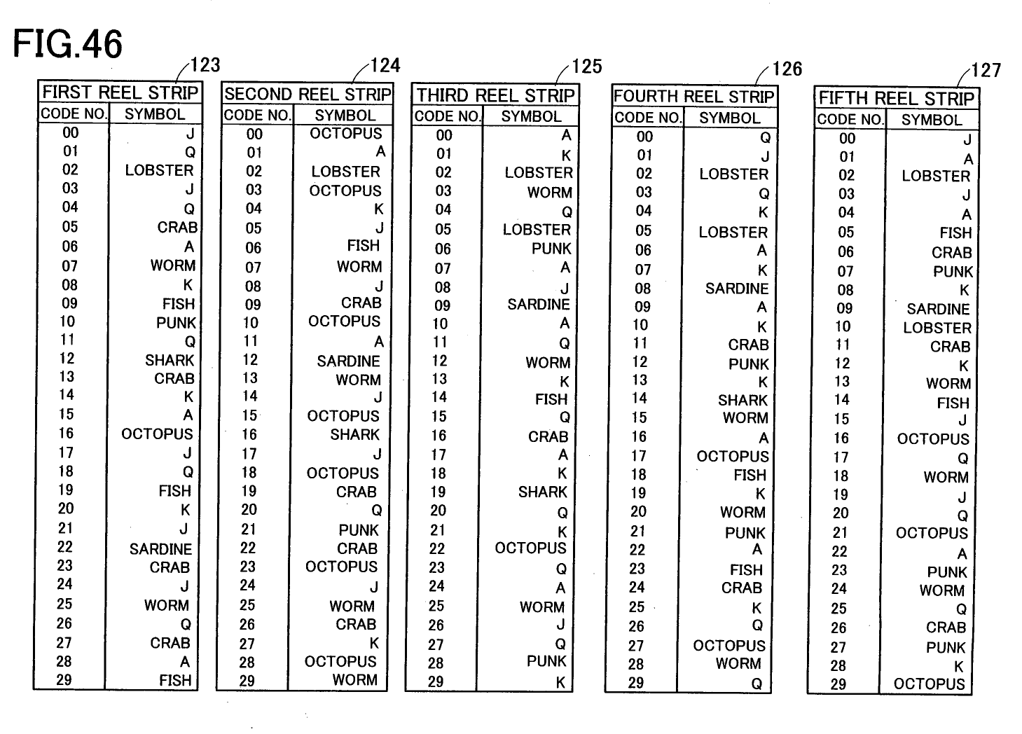

By the way, in the slot machine 1 according to the embodiment, when the bonus game is conducted, the symbol row variably displayed while being scrolled on the variable display portion 21 of the lower liquid crystal display 4 is the symbol row indicated by the first reel strip 123 shown in FIG. 46, the symbol row variably displayed while being scrolled on the variable display portion 22 of the lower liquid crystal display 4 is the symbol row indicated by the second reel strip 124 shown in FIG. 46, the symbol row variably displayed while being scrolled on the variable display portion 23 of the lower liquid crystal display 4 is the symbol row indicated by the third reel strip 125 shown in FIG. 46, the symbol row variably displayed while being scrolled on the variable display portion 24 of the lower liquid crystal display 4 is the symbol row indicated by the fourth reel strip 126 shown in FIG. 46 and the symbol row variably displayed while being scrolled on the variable display portion 25 of the lower liquid crystal display 4 is the symbol row indicated by the fifth reel strip 127 shown in FIG. 46.

Here, the symbol rows indicated by the reel strips 123 to 126 shown in FIG. 46 are as same as those indicated by the reel strips 101 to 104 shown in FIG. 6. On the other hand, the symbol row indicated by the reel strip 127 shown in FIG. 46 is substantially as same as the symbol row indicated by the reel strip 105 shown in FIG. 6, except for the symbol “LOBSTER” (shown in FIG. 7) allotted to the code No. “10”.

Here, as the bet number and the number of activated pay line in the bonus game, the bet number and the number of activated pay line set in the base game are utilized, respectively. And in the bonus game, although the winning symbol combinations and payouts thereof in the bonus game are as same as those in the base game, the symbol “SHARK” is handled as the symbol “LOBSTER” (shown in FIG. 7) and if more than three symbols “SARDINE” totally appear (are totally stopped and displayed), the game state in the bonus game can be again shifted to the bonus game. Therefore, the player can obtain a lot of credits in many cases.

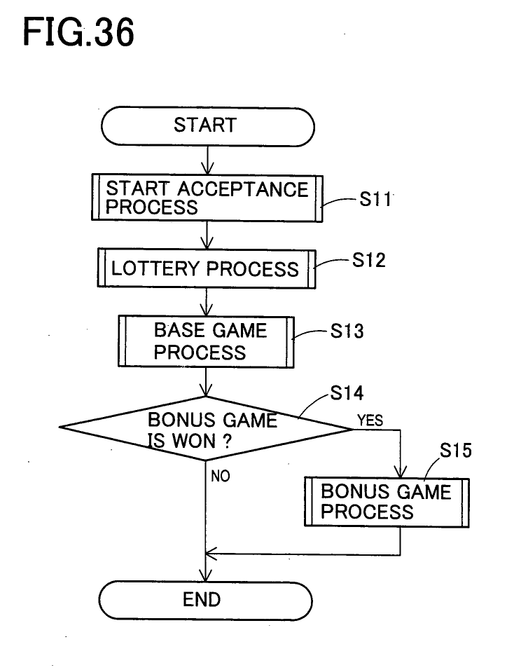

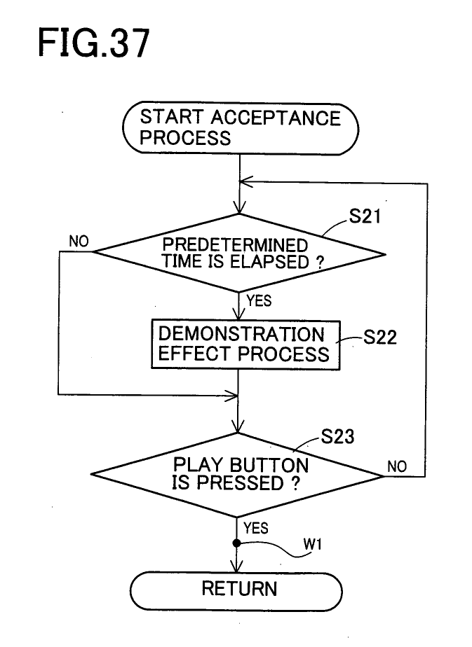

Next, the main process program done in the slot machine 1 will be described with reference to FIG. 36. FIG. 36 is a flowchart of the main process program. In FIG. 36, at first, in step (abbreviated as “S” hereinafter) 11, a start acceptance process shown in FIG. 37 is done. This process is a process for accepting the switch signal output from the 1-BET switch 57, the 2-BET switch 58, the 3-BET switch 59, the 5-BET switch 60, the 8-BET switch 61, the 1-LINE switch 62, the 2-LINES switch 63, the 5-LINES switch 64, the 20-LIENS switch 65, the 25-LINES switch 66, based on operation of the BET 1 PER LINE button 33, the BET 2 PER LINES button 34, the BET 3 PER LINES button 35, the BET 5 PER LINES 36, the BET 8 PER LINES button 37, the RED PLAY 1 LINE button 39, the PLAY 2 LINES button 40, the PLAY 5 LINES button 41, the PLAY 20 LINES button 42 or the BLACK PLAY 25 LINES button 43. When the switch signal output from each switch is accepted, the game is started.

And in S12, a lottery process shown in FIG. 16 mentioned later is done based on the switch signal output from the 1-LINE switch 62, the 2-LINES switch 63, the 5-LINES switch 64, the 20-LINES switch 65, the 25-LINES switch 66.

Here, if the bonus game is won, a repeat number of the bonus game is determined. In this case, for example, such repeat number is selected among 10˜25 games by a lottery.

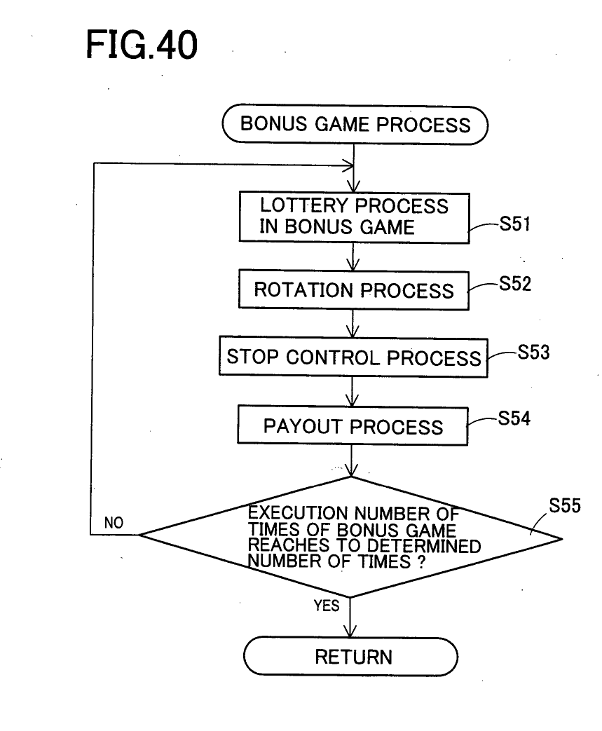

Next, in S13, a base game process shown in FIG. 17 mentioned later is done. Thereafter, procedure shifts to S14 and it is determined whether or not the bonus game is won. Concretely, in the lottery process in S12, if more than three symbols “SARDINE” totally appear (are stopped and displayed) on the variable display portions 21 to 25 with no relation to the activated pay lines, the bonus game is won (S14: YES). Thereby, procedure shifts to S15 and the main process program is terminated after the bonus game process shown in FIG. 40 mentioned later is done. On the other hand, in the lottery process of S12, if more than three symbols “SARDINE” does not totally appear (are not stopped and displayed) on the variable display portions 21 to 25 with no relation to the activated pay lines, the bonus game is not won (S14: NO), thereby the main process program is terminated.

Next, the start acceptance process program conducted in the slot machine 1 will be described with reference to FIG. 37. FIG. 37 is a flowchart of the start acceptance process program. In S11 of the main process program shown in FIG. 36, the start acceptance process is conducted. Here, to conduct this process, at first, procedure shifts to S21 of FIG. 37 and it is determined whether or not a predetermined time (for example, 15 seconds) is elapsed. Here, if it is determined that the predetermined time is not elapsed (S21: NO), procedure shifts to S23, and on the other hand, if it is determined that the predetermined time is elapsed (S21: YES), demonstration effect is done on the upper liquid crystal display 3 or the lower liquid crystal display 4 in S22, thereafter procedure shifts to S23. And in S23, it is determined whether or not operation of the RED PLAY 1 LINE button 39, the PLAY 2 LINES button 40, the PLAY 5 LINES button 41, the PLAY 20 LINES button 42 or the BLACK PLAY 25 LINES button 43 is done. Here, if it is determined that operation of the RED PLAY 1 LINE button 39 and the like is not done (S23: NO), procedure returns to S21 and the above procedures are repeated. On the other hand, if it is determined that operation of the RED PLAY 1 LINE button 39 and the like is done (S23: YES), procedure returns to the main process program of FIG. 36 and shifts to the lottery process in S12 even while the demonstration effect is done.

Here, in the determination process in S23, such determination in S23 may be conducted based on the other input signals other than the above operation signals.

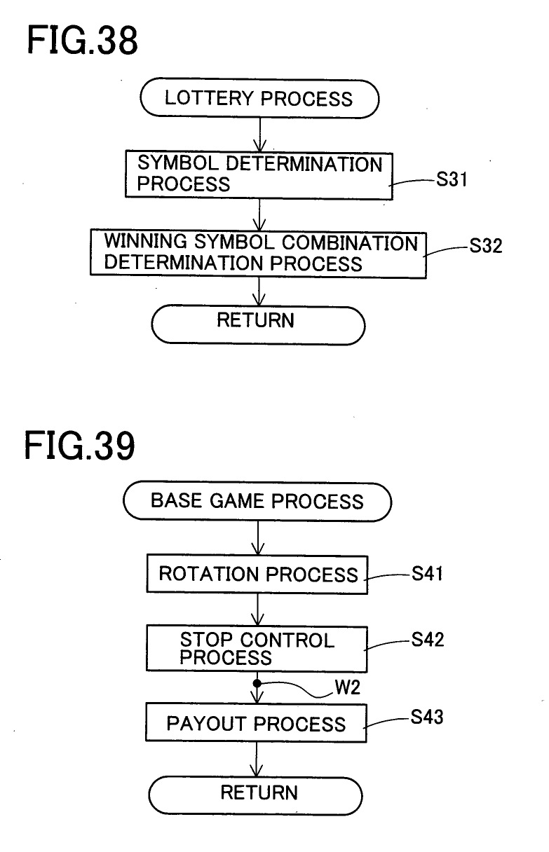

Next, the lottery process program done in the slot machine 1 will be described with reference to FIG. 38. FIG. 38 is a flowchart of the lottery process program. In S12 of the main process program shown in FIG. 36, the lottery process is done. To conduct this process, at first, procedure shifts to S31 of FIG. 38 and a symbol determination process is conducted. Here, the symbols stopped and displayed on the first pay line L1 in the base game are determined every each of the variable display portions 21 to 25. Concretely, as mentioned above, five random number values are sampled by the random number sampling circuit 56 so as to correspond to each of the variable display portions 21 to 25 and the symbols stopped and displayed are determined through the code Nos. based on the lottery table shown in FIG. 9. And if the symbols stopped and displayed on the activated pay line are determined, a determination process of the winning symbol combination is done in S32, thereafter procedure returns to the main process program in FIG. 36 and shifts to the base game process in S13. Here, concretely speaking, in the determination process of the winning symbol combination, the winning symbol combination and the payout thereof are determined based on the table shown in FIG. 8 through the code No. obtained in S31, as mentioned.

Next, the base game process program done in the slot machine 1 will be described with reference to FIG. 39. FIG. 39 is a flowchart of the base game process program. In S13 of the main process program shown in FIG. 36, the base game is conducted. To realized this, at first, in S41 of FIG. 39, scroll of each of the symbols is done on the variable display portions 21 to 25 based on the switch signal output from the 1-LINE switch 62, the 2-LINES switch 63, the 5-LINES switch 64, the 20-LINES switch 65 or the 25-LINES switch 66, the switch signal being accepted in S11 of FIG. 36.

And in S42, scroll of each of the symbols on the variable display portions 21 to 25 is stopped.

Further, in S43, according to the symbol combination corresponding to the winning symbol combination stopped and displayed on the variable display portions 21 to 25, the credit corresponding to the payout determined on the basis of the table shown in FIG. 8 is paid out. Here, after process in S43 is done, procedure shifts to the main process program shown in FIG. 36 and shifts to the determination process in S14.

Next, the bonus game process program done in the slot machine 1 will be described with reference to FIG. 39. FIG. 39 is a flowchart of the bonus game process program. In S14 of the main process program shown in FIG. 36, if it is determined that the bonus game is won (S14: YES), procedure shifts to S15 of FIG. 36 and the bonus game process is conducted. To realize this, at first, procedure shifts to S39 shown in FIG. 39 and the lottery process during the bonus game is done. Here, in the bonus game, the symbols stopped and displayed on the first pay line L1 are determined every each of the variable display portions 21 to 25. Concretely, as mentioned, five random number values are sampled by the random number sampling circuit 56 so as to correspond to each of the variable display portions 21 to 25, and the symbols stopped and displayed are determined through the code Nos. based on the lottery table shown in FIG. 9. And if the symbols stopped and displayed on the first pay line L1 are determined, the winning symbol combination and the payout thereof are determined based on the table shown in FIG. 8 through the code Nos.

Further, in the rotation process in S52, scroll of each of the symbols is automatically done on the variable display portions 21 to 25.

And in the stop control process in S53, scroll of each of the symbols on the variable display portions 21 to 25 is stopped.

Further, in the payout process in S54, according to the symbol combination corresponding to the winning symbol combination stopped and displayed on the variable display portions 21 to 25, the credit corresponding to the payout determined based on the table in FIG. 8 (however, the symbol “SHARK” is handled as the symbol “LOBSTER (shown in FIG. 7)) is paid out.

Next, procedure shifts to S55 and it is determined whether or not the execution number of times of the bonus game reaches to the number of times determined in S12 of FIG. 36. At that time, if it is determined that the execution number of times of the bonus game does not reach to the number of times already determined (S55: NO), procedure returns to S51 and the above processes are repeated. On the other hand, if it is determined that the execution number of times of the bonus game reaches to the number of times already determined (S55: YES), the bonus game process program is terminated.

Here, if the bonus game is won in S51, the repeat number of times of the bonus game is determined again and the determined repeat number of times is added to the “number of times determined in S12 of FIG. 36” used in the determination process in S55. Thereby, when the bonus game is won during the bonus game, procedure can again shift to the bonus game. Concretely speaking, for example, in a case that procedure shifts to the bonus game with 20 number of times for the first time and the bonus game with 17 number of times is won in the twelfth bonus game, the bonus games are conducted in 25 times (20 times−12 times+17 times) thereafter.

And if the credit can be finally obtained in the bonus game, a double down game to bet the credit is done after the bonus game is terminated. This double down game will be omitted.

As mentioned in the above, the CPU 50 functions as “game controller” when the main process program of FIG. 36 is executed.

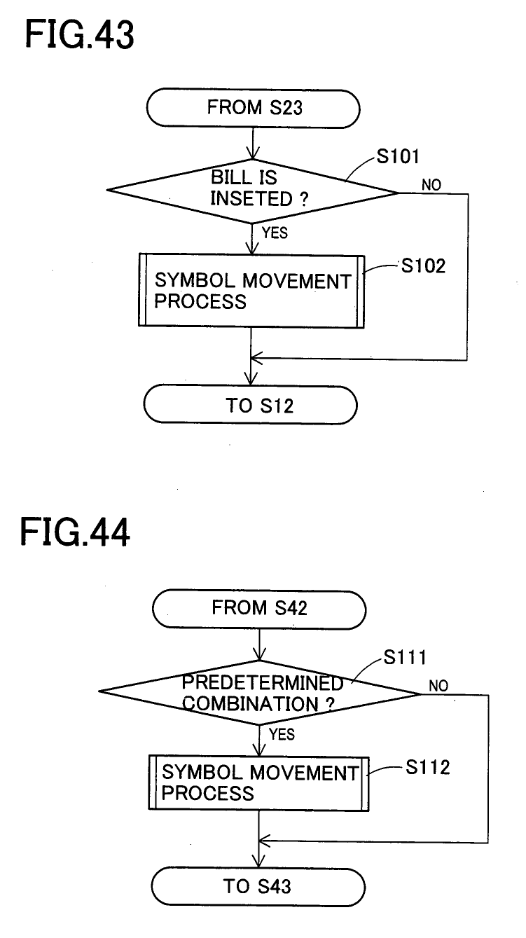

By the way, in the slot machine 1 according to the embodiment, when the symbols stopped and displayed on each of the variable display portions 21 to 25 are touched and a predetermined condition is realized, the symbols touched can be moved and effect sounds can be output. In order to realized this, for example, the process shown in FIG. 43 is conducted at the time point W right after the determination process of S23 in the start acceptance process program in FIG. 37 is done. That is to say, in the start acceptance process program of FIG. 37, if it is determined that the play button is pressed (S23: YES), procedure shifts to S101 in FIG. 43 and it is determined whether or not a bill is inserted in S101. Concretely, this determination is done based on whether or not the bill detection signal is output from the bill sensor 67. At that time, if it is determined that the bill is not inserted (S101: NO), procedure returns to the start acceptance process program in FIG. 37 and shifts to S12 of the main process program in FIG. 36. On the other hand, it is determined that the bill is inserted (S101: YES), procedure shifts to S102 and a symbol movement process mentioned later is done, thereafter procedure returns to start acceptance process program in FIG. 37 and shifts to S12 of the main process program in FIG. 36.

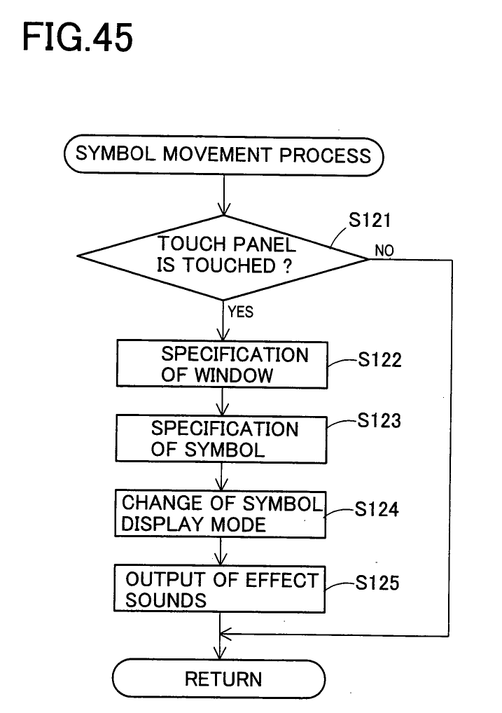

Here, the symbol movement process in S102 shown in FIG. 43 will be described with reference to FIG. 45. FIG. 45 is a flowchart of the symbol movement process. That is to say, as shown in FIG. 45, in the symbol movement process, at first, it is determined whether or not the touch panel 121 is touched within the variable display portions 21 to 25 in S121. At that time, if it is determined that the touch panel 121 is not touched within the variable display portions 21 to 25 (S121: NO), procedure returns to the process shown in FIG. 43. On the other hand, if it is determined that the touch panel 121 is touched within the variable display portions 21 to 25 (S121: YES), procedure shifts to S122.

And in S122, the window touched by the finger is specified. Here, the window is defined as any of the first stop areas 211, 221, 231, 241, 251, the second stop areas 212, 222, 232, 242, 252 and the third stop areas 213, 223, 233, 243, 253, within the variable display portions 21 to 25. Further, when procedure shifts to S123, the symbol stopped and displayed on the specified window is also specified.

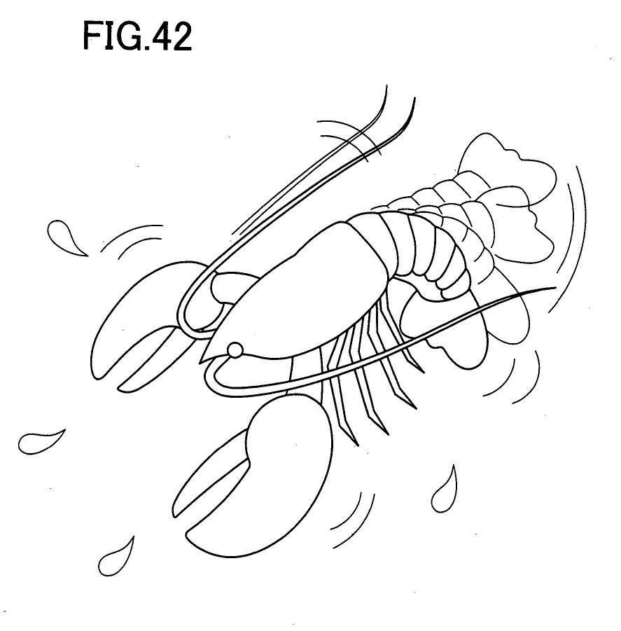

And when procedure shifts to S124, the display mode of the symbol specified in S123 is changed within the specified window. Concretely, for example, in a case that the symbol specified in S123 is the symbol “LOBSTER” (shown in FIG. 7), the image that the lobster springs as shown in FIG. 42 is displayed.

Further, when procedure shifts to S125, the effect sounds corresponding to change of the display mode in S124 are output, thereafter procedure returns to the process in FIG. 43. As for the concrete effect sounds, for example, if the symbol specified in S123 is the symbol “LOBSTER” (shown in FIG. 7), the effect sounds such as sprightly sounds representing springing lobster as shown in FIG. 42 are output.

Here, the images that the display mode of the symbol is changed are stored in the image ROM 82, every each of the symbol “LOBSTER”, the symbol “SHARK”, the symbol “FISH”, the symbol “PUNK”, the symbol “OCTOPUS”, the symbol “CRAB”, the symbol “WORM”, the symbol “SARDINE”, the symbol “A”, the symbol “K”, the symbol “Q” and the symbol “J”. And the symbol specified in S123 is read out and output in the window specified in S122. Further, the effect sounds when the display mode of the symbol is changed are stored in the ROM 51, every each of the symbol “LOBSTER”, the symbol “SHARK”, the symbol “FISH”, the symbol “PUNK”, the symbol “OCTOPUS”, the symbol “CRAB”, the symbol “WORM”, the symbol “SARDINE”, the symbol “A”, the symbol “K”, the symbol “Q” and the symbol “J”. And the effect sounds of the symbol specified in S123 are read out and output from the speaker 80.

As mentioned above, the CPU 50 functions as “first permission device” when the process program in FIG. 43 is executed. And the CPU 50 functions as “symbol movement device” when the symbol movement process program in FIG. 45 is executed.

Further, only when the symbol combination stopped and displayed on each of the variable display portions 21 to 25 is the predetermined symbol combination, the symbol can be moved and the effect sounds can be output based on that the symbol stopped and displayed on each of the variable display portions 21 to 25 is touched by the finger.

In order to realize the above, for example, the process shown in FIG. 44 is conducted at the time point W2 right after the stop control process of S42 in the base game process program in FIG. 39 is done. That is to say, in the base game process program shown in FIG. 39, if the stop control process in S42 is executed, procedure shifts to S111 in FIG. 44 and it is determined whether or not the symbol combination stopped and displayed on each of the variable display portions 21 to 25 is the predetermined symbol combination. At that time, if it is determined that the symbol combination stopped and displayed on each of the variable display portions 21 to 25 is not the predetermined symbol combination (S111: NO), procedure shifts to S43 of the base game process program in FIG. 39. On the other hand, if the symbol combination stopped and displayed on each of the variable display portions 21 to 25 is the predetermined symbol combination (S111: YES), procedure shifts to S112 and the symbol movement process in FIG. 45 already mentioned is conducted, thereafter procedure shifts to S43 of the base game process program in FIG. 39.

As mentioned, when the program shown in FIG. 44 is executed, the CPU 50 functions as “second permission device”.

Here, as for the predetermined symbol combinations in determination process of S111, for example, it is conceivable a case that the symbol combination stopped and displayed on each of the variable display portions 21 to 25 is the symbol combination corresponding to the winning symbol combination shown in FIG. 8. At that time, the object to be determined in S111 may be limited to the symbol combination stopped and displayed on the pay line which is activated among the pay lines L1˜L25. In this case, concerning with only the symbol combination corresponding to the winning symbol combination shown in FIG. 8, the display mode thereof may be changed and the effect sounds may be output.

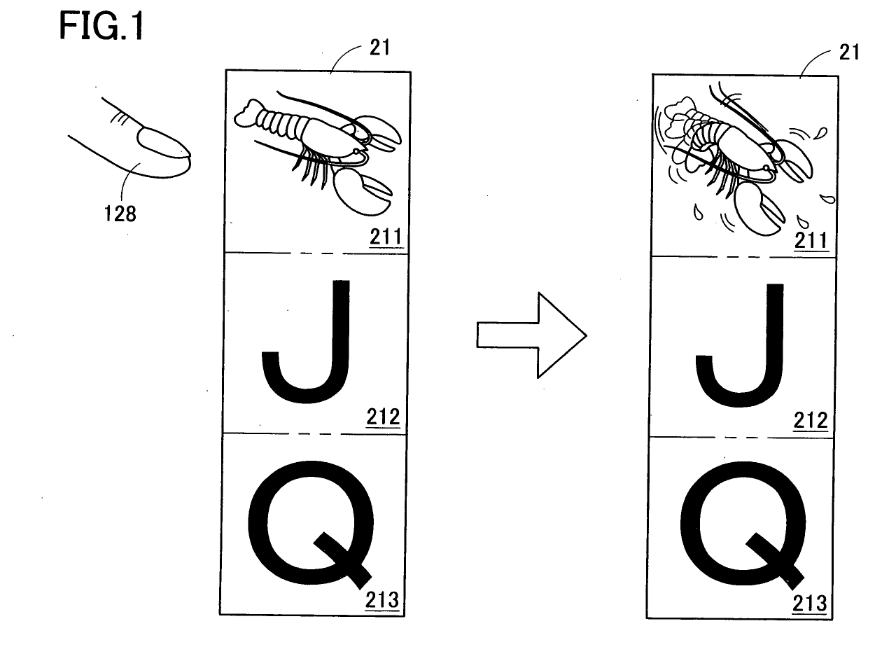

As detailedly mentioned in the above, in the slot machine 1 according to the embodiment, at the time that the game state shifts from one base game to another base game, when a bill is inserted in the bill insertion portion 10 in a case that, for example as shown in FIG. 1, the symbol “LOBSTER” is stopped and displayed on the first stop area 211, the symbol “J” is stopped and displayed on the second stop area 212 and the symbol “Q” is stopped and displayed on the third stop area 213, within the variable display portion 21, the symbol “LOBSTER” displayed on the first stop area 211 is displayed so as to spring and the effect sounds representing springing lobster are output when the player touches on the first stop area 211 by the finger 128. Therefore, since the display mode of the symbol “LOBSTER” is changed when the player touches the symbol “LOBSTER” which is stopped and displayed, the player can change the display mode of the symbol “LOBSTER” by player's operation. Thereby, it can predict that meditation and attachment of the player against the symbol “LOBSTER” increases, thus familiarity of the player for the video slot machine can be increased. Accordingly, it is expected that repeaters who plays the video slot machine can be obtained.

Here, the above point that the display mode of the symbol can be changed is not limited to the first stop area 211 in the variable display portion 21 and can be realized on the second stop area 212 or the third stop area 213 in the variable display portion 21. Further, similarly, the above point can be also realized on the first stop areas 221, 231, 241, 251, the second sop and display areas 222, 232, 242, 252 and the third atop and display areas 223, 233, 243, 253.

And the above point is not limited to the symbol “LOBSTER” and can be realized in each symbol of “SHARK”, “FISH”, “PUNK”, “OCTOPUS”, “CRAB”, “WORM” “SARDINE”, “A”, “K”, “Q”, and “J”.

Further, the above point can be similarly realized in a case that the symbol combination stopped and displayed on each of the variable display portions 21 to 25 is the predetermined symbol combination (for example, the symbol combination corresponding to the winning symbol combination shown in FIG. 8).

Here, the present invention is not limited to the above embodiment and various changes and modifications can be done within the scope of the present invention.

For example, in the slot machine 1, when the player touches the symbol stopped and displayed on each of the variable display portions 21 to 25 on a condition that a bill is inserted in the bill insertion portion 10 (S101: YES), such symbol can be moved and the effect sounds can be output (S124. S125). As for this point, it may be set the condition that coins are inserted in the coin insertion slot 9 (the coin detection signal from the coin sensor 49 is received). And it may be set the condition while the bonus game process in FIG. 40 is executed or the start acceptance process in FIG. 37 is executed. Further, without any condition, it is conceivable that the symbol stopped and displayed on each of the variable display portions 21 to 25 can be always moved and the effect sounds can be always output when the player touches such symbol by the finger 128.

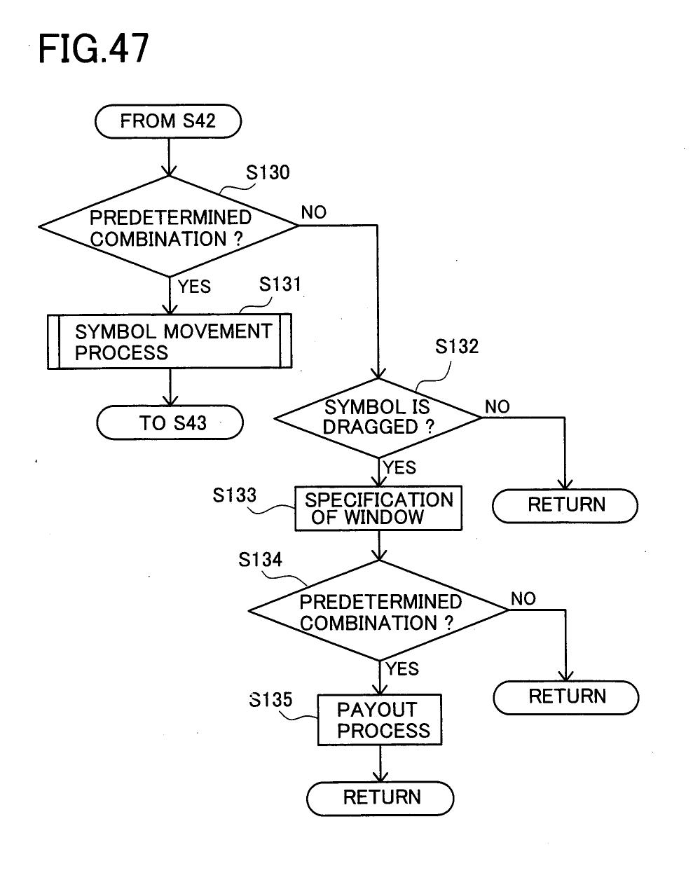

Further, at W2 of FIG. 39, the gaming machine of the present invention may run the following processes shown in FIG. 47 alternatively to the steps described in FIG. 44. In this embodiment, the symbol “LOBSTER” is used as a wild symbol.

Namely, as shown in FIG. 47, in the base game process program shown in FIG. 39, after the stop control process in S42 is executed, procedure shifts to S130 in FIG. 47 and it is determined whether or not the symbol combination stopped and displayed on each of the variable display portions 21 to 25 is the predetermined symbol combination. At that time, if it is determined that the symbol combination stopped and displayed on each of the variable display portions 21 to 25 is the predetermined symbol combination (S130: YES), procedure shifts to S131 and the symbol movement process in FIG. 45 already mentioned is conducted, thereafter procedure shifts to S43 of the base game process program in FIG. 39. On the other hand, if it is determined that the symbol combination stopped and displayed on each of the variable display portions 21 to 25 is not the predetermined symbol combination (S130: NO), procedure shifts to S132 and the gaming machine may request the player to drag the symbol “LOBSTER” onto a desirable stop area, as shown in S132 of FIG. 47 so as to provide award. That is, it is determined in S132 whether or not the symbol “LOBSTER” is dragged onto any one of the stop areas. If it is determined that the symbol “LOBSTER” is not dragged (S132: NO), procedure shifts to the main process program shown in FIG. 36. On the contrary, if it is determined that the symbol “LOBSTER” is dragged onto any one of the stop areas (S132: YES), the CPU 50 determines in S133 to which window the symbol “LOBSTER” has been dragged on. Namely, the window to which the symbol “LOBSTER” has been dragged on is specified in S133. Thereafter, the CPU 50 determines in S134 whether thus dragged symbol “LOBSTER” forms a predetermined combination that results in award. That is, it is determined in S134 whether or not the winning symbol combination is formed based on that the symbol “LOBSTER” is dragged onto the stop area. If determined “NO” in S134, procedure shifts to the main process program shown in FIG. 36. On the contrary, if determined “YES” in S134, procedure shifts to S135, where the award is given to the player. That is, in S135, according to the winning symbol combination, the coins are paid out. Thereafter, procedure shifts to the main process program shown in FIG. 36.

The above mentioned dragging process may be combined with the symbol movement process described in FIG. 44. Namely, after determined as “YES” in S111 of FIG. 44, the gaming machine of the present invention may require the player to drag the symbol “LOBSTER” to a desirable stop area so as to obtain additional awards. Thereafter the CPU 50 may run the symbol movement process so that the player can see that the symbol “LOBSTER” has resulted in the additional awards.

Although the embodiment above is described as a process in base game, the dragging may be carried out in bonus game like free game.

And the present invention is not limited to the video slot machine, and for example, when the player touches the symbol stopped and displayed on the lower liquid crystal display 4 by the finger 128 in the game (for example, the poker game in which trump symbols are used) that is executed by using symbols displayed on the lower liquid crystal display 4, the symbol may be moved and the effect sounds may be output.

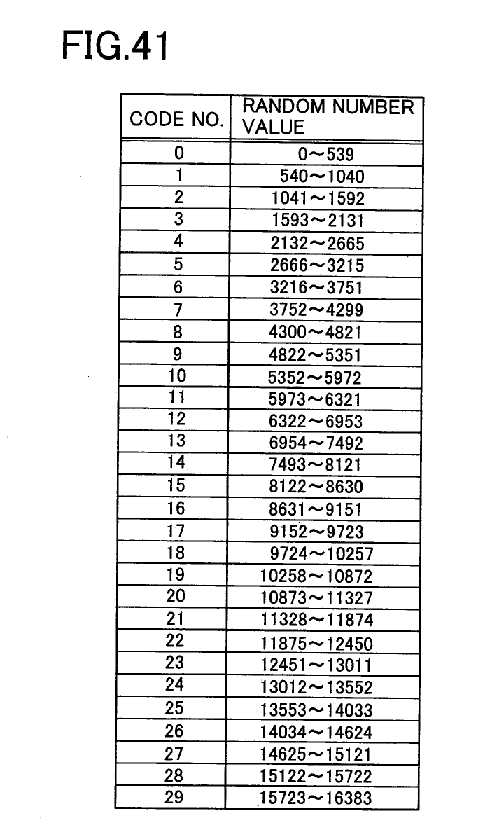

Further, in the slot machine 1 of the embodiment, the symbol stopped and displayed on the first pay line L1 is determined every each of the variable display portions 21 to 25 in the base game and the bonus game, based on the lottery table in FIG. 9 in which one random number value sampled through the random number sampling circuit 56 and one code No. are corresponded with each other. As for this point, for example, the symbol stopped and displayed on the first pay line L1 may be determined every each of the variable display portions 21 to 25, based on the lottery table in FIG. 41 in which a specific range of the random numbers sampled through the random number sampling circuit 56 corresponds to one code No. The present invention can be applied when the game is executed by using symbols displayed on the display device.

1. A gaming machine having a display device for variably displaying and stopping symbols thereon and a game controller for conducting a payout corresponding to a symbol combination stopped and displayed on the display device,
the gaming machine comprising:
a touch input device which is arranged on an image plane of the display device; and
a symbol movement device for changing a display mode of the symbol stopped and displayed on the display device when the symbol is touched through the touch input device.

2. The gaming machine according to claim 1, further comprising:
a detection device for detecting whether or not a game medium is inserted in the gaming machine; and
a first permission device for permitting the symbol movement device to execute changing of the display mode of the symbol when the detection device detects insertion of the game medium.

3. The gaming machine according to claim 2, further comprising:
a sound output device for outputting effect sounds corresponding to movement of the symbol when the display mode of the symbol is changed.

4. The gaming machine according to claim 1, further comprising:
a second permission device for permitting the symbol movement device to execute changing of the display mode of the symbol when the symbol combination stopped and displayed on the display device is a predetermined symbol combination.

5. The gaming machine according to claim 4, further comprising:
a sound output device for outputting effect sounds corresponding to movement of the symbol when the display mode of the symbol is changed.
